(19) United States
(12) Patent Application Publication
(10) Pub. No.: US 2010/0085513 A1
(43) Pub. Date: Apr. 8, 2010

(54) VIEWING ANGLE CONTROL PANEL AND LIQUID CRYSTAL DISPLAY DEVICE

(76) Inventors: Dai Chiba, Mie (JP); Tsuyoshi Okazaki, Nara (JP); Katsuhiko Morishita, Mie (JP); Yoshiharu Kataoka, Mie (JP); Chikanori Tsukamura, Mie (JP); Takehiko Sakai, Mie (JP)

Correspondence Address: NIXON & VANDERHYE, PC, 901 NORTH GLEBE ROAD, 11TH FLOOR, ARLINGTON, VA, 22203, US

(21) Appl. No.: 12/441,993

(22) PCT Filed: Sep. 12, 2007
(86) PCT No.: PCT/JP2007/067759

§ 371 Date: Mar. 19, 2009

(30) Foreign Application Priority Data
Nov. 20, 2006 (JP) 2006-313581

(51) Int. Cl. G02F 1/1347; G02F 1/1333; G02F 1/1343

(52) U.S. Cl. 349/74; 349/122; 349/139

(57) ABSTRACT

A viewing angle control panel (2) that includes two substrates (4 and 6) facing each other and liquid crystal layer (5) provided between the substrates and that is usable in combination with a display panel (10) so as to allow a liquid crystal display device (1) to switch a viewing angle characteristic, wherein: one of the substrates (6) includes a counter electrode pattern (62) in which a counter electrode is provided over the one of the two substrates; and the other one of the substrates (4) includes a transparent electrode pattern (49) in which transparent electrodes (49a through 49d) are provided in a striped manner and first and second wire electrodes (e.g., wire electrodes 48a and 48b) that are provided for each space (e.g., a space 51x) between the transparent electrodes in the transparent electrode pattern (49) in such a manner that the first the second wire electrodes, positioned in parallel with the transparent electrodes, respectively, overlap the space 51x. In the arrangement, electric potential settings of wiring electrodes (48a through 48f) are changed. This makes it possible to switch a visibility limitation direction.

### TECHNICAL FIELD

The present invention relates to a viewing angle control panel capable of switching a viewing angle characteristic of a liquid crystal display device.

### BACKGROUND ART

A display device is generally required to have a viewing angle characteristic (a wide viewing angle characteristic) that allows a clear image to be viewed from many viewing points. However, it is sometimes preferable that only an intended user of a display device can view display contents under a certain surrounding environment. For example, a laptop type personal computer, a mobile information terminal (PDA: Personal Data Assistant), or a mobile phone, is more likely to be used in a place (e.g., in a train, airplane, etc.) where general public can be present. Under such a surrounding environment, it is desirable in view of at least preservation of confidentiality and privacy protection that a display device adopts a viewing angle characteristic (a narrow viewing angle characteristic) that allows only its intended user to view a display image while preventing others from viewing it (i.e., a viewing angle characteristic that allows a display image to be viewed only at a particular viewing point but not at other viewing points).

Thus, a demand has been recently increased for a display device in which a viewing angle characteristic can be switched between a wide viewing angle characteristic and a narrow viewing angle characteristic.

In order to meet such a demand, Patent Document 1, for example, discloses a liquid crystal display device in which (i) a viewing angle control liquid crystal panel is provided on a display liquid crystal panel and (ii) the liquid crystal panels are sandwiched between two polarization plates. With such a liquid crystal display device, it is possible to control a viewing angle characteristic by adjusting a voltage applied to the viewing angle control liquid crystal panel.

### CITATION LIST

Patent Literature 1

Japanese Patent Application Publication, Tokukai-hei, No. H10-268251 (Publication Date: Oct. 9, 1998)

### SUMMARY OF INVENTION

In the conventional liquid crystal display device, however, the viewing angle control liquid crystal panel and an upper polarization plate require to be provided in accordance with a rubbing direction of a substrate constituting the display liquid crystal panel (or in accordance with a direction of a polarization axis of a lower polarization plate). As such, (i) a visible direction and (ii) an invisible direction (visibility limitation direction), occurred when a viewing angle characteristic is a narrow viewing angle characteristic, are determined based on a structure of the display liquid crystal panel. This causes a problem that it is impossible to change the visibility limitation direction.

The present invention is made in view of the problem, and an object of the present invention is to provide a viewing angle control panel for allowing a visibility limitation direction to be switched.

A viewing angle control panel of the present invention is a viewing angle control panel including two substrates facing each other and a liquid crystal layer provided between the substrates, a combination of the viewing angle control panel and a display panel constituting a liquid crystal display device in which a viewing angle characteristic can be switched, wherein: (i) one of the two substrates includes a counter electrode pattern in which a counter electrode is provided over the one of the two substrates and (ii) the other one of the two substrates includes a transparent electrode pattern in which transparent electrodes are provided in a striped manner; and two wire electrodes are provided in parallel with transparent electrodes so as to correspond to respective of spaces in the transparent electrode pattern and such that the two wire electrodes and the respective of the spaces overlap each other, respectively.

In the arrangement, the wire electrodes are provided such that (i) the two wire electrodes and (ii) vicinity of each transparent electrode edge in a direction, in which the transparent electrode extends, overlap each other. This allows, in a case where an electric potential of the transparent electrode is controlled, an equipotential line in the liquid crystal line to be changed in the vicinity of each transparent electrode edge, the equipotential line in the liquid crystal layer being occurred when a voltage is applied. That is, it is possible, by changing an electric potential setting of the transparent electrode, to change a direction in which liquid crystal molecules are tilted in the liquid crystal layer. Also, it is possible, by setting a voltage between the transparent electrode and the counter electrode, to control an angle at which the liquid crystal molecules are tilted. This, in turn, makes it possible to change (switch) the visibility limitation direction occurred when the viewing angle characteristic is a narrow viewing angle characteristic.

It is preferable in the viewing angle control panel of the present invention that the two wire electrodes are a first wire electrode and a second wire electrode, and the first wire electrode and one side end part of the respective of the spaces overlap each other, and the second wire electrode and the other side end part of the respective of the spaces overlap each other. This makes it possible to change the equipotential line with accuracy in the vicinity of each transparent electrode edge.

The viewing angle control panel of the present invention can be arranged such that: two transparent electrodes between which the respective of the spaces is sandwiched are a first transparent electrode and a second transparent electrode, and the two wire electrodes are a first wire electrode and a second wire electrode; and the first and second wire electrodes are provided in a single layer. In the arrangement, (i) the first and second wire electrodes and (ii) the transparent electrode pattern can be alternatively provided in different layers, respectively. In this case, the first wire electrode and one side end part of the first transparent electrode can overlap each other, and the second wire electrode and one side end part of the second transparent electrode can overlap each other. The substrate, including the transparent electrode pattern, can include the first and second wire electrodes. Alternatively, the substrate, including the counter electrode pattern, can include the first and second wire electrodes. Besides, (i) the first and second wire electrodes and (ii) the transparent electrode pattern can be provided in a single layer. In this case, the first wire electrode should be provided close to the first transparent electrode, and the second wire electrode should be provided close to the second transparent electrode.

The viewing angle control panel of the present invention can be arranged such that two transparent electrodes between which the respective of the spaces is sandwiched are a first transparent electrode and a second transparent electrode; and the two wire electrodes are a first wire electrode and a second wire electrode; and the first and second wire electrodes are provided in different layers, respectively. It is preferable in the arrangement that the first wire electrode and one side end part of the first transparent electrode overlap each other, and the second wire electrode and one side end part of the second transparent electrode overlap each other. Furthermore, it is desirable that the first and second wire electrodes overlap each other. This allows the wire electrodes and the spaces in the transparent electrode pattern to overlap each other, thereby making it possible to prevent the liquid crystal layer from having a region in which no voltage is applied. In this case, the substrate including the counter electrode pattern can include the first and second wire electrodes. Alternatively, the substrate including the counter electrode pattern can include the first wire electrode, and the substrate including the transparent electrode pattern can include the second wire electrode. Alternatively, the substrate including the transparent electrode pattern can include the first and second wire electrodes. Specifically, (i) the first and second wire electrodes are provided in a layer below a layer in which the transparent electrode pattern is provided, (ii) the first and second wire electrodes are provided in a layer above a layer in which the transparent electrode pattern is provided, or (iii) the transparent electrode pattern is provided between a layer in which the first wire electrode is provided and a layer in which the second wire electrode is provided.

A viewing angle control panel of the present invention is a viewing angle control panel including two substrates facing each other and a liquid crystal layer provided between the substrates, a combination of said viewing angle control panel and a display panel constituting a liquid crystal display device in which a viewing angle characteristic can be switched, wherein: (i) one of the two substrates includes a counter electrode pattern in which a counter electrode is provided over the one of the two substrates, and (ii) the other one of the two substrates includes a transparent electrode pattern in which a transparent electrodes is provided over the other one of the two substrates; and plural pairs of two wire electrodes are provided, between the counter electrode pattern and the transparent electrode pattern, at intervals in a width direction orthogonal to a direction in which the wire electrodes extend and orthogonal to a normal direction of a substrate surface, the two wire electrodes of each of the plural pairs being provided in parallel with each other and being close to or overlapping each other in the width direction.

In the arrangement, an electric potential of each wire electrode is controlled. This can cause a change in the equipotential line in the liquid crystal layer, the equipotential line in the liquid crystal layer being occurred when a voltage is applied. That is, it is possible, by changing the electric potential setting of each wire electrode, to change a direction in which liquid crystal molecules are tilted in the liquid crystal layer. Also, it is possible, by setting a voltage between the transparent electrode and the counter electrode, to control an angle at which the liquid crystal is tilted. This makes it possible to change (switch) a visibility limitation direction occurred when a viewing angle characteristic is a narrow viewing angle characteristic.

The viewing angle control panel of the present invention can be arranged such that the two wire electrodes of each of the plural pairs are provided in a single layer. Alternatively, the viewing angle control panel of the present invention can be arranged such that the two wire electrodes of each of the plural pairs are provided in different layers, respectively. In this case, the viewing angle control panel of the present invention can also be arranged such that the two wire electrodes include a part where they overlap each other and a part where they do not overlap each other. Also, the viewing angle control panel of the present invention can be arranged such that the substrate including the counter electrode pattern includes the plural pairs of two wire electrodes. Alternatively, the viewing angle control panel of the present invention can be arranged such that the substrate including the counter electrode pattern includes ones of the plural pairs of two wire electrodes, and the substrate including the transparent electrode pattern includes the other ones of the plural pairs of two wire electrodes. Alternatively, the viewing angle control panel of the present invention can be arranged such that the substrate including the transparent electrode pattern includes the plural pairs of two wire electrodes.

With the arrangement, setting of electric potentials, being applied to the two wire electrodes in each of the plural pairs, is changed so that a direction in which visibility of the liquid crystal display device is limited can be changed.

A viewing angle control panel of the present invention is a viewing angle control panel including two substrates facing each other and a liquid crystal layer provided between the substrates, a combination of the viewing angle control panel and a display panel constituting a liquid crystal display device in which a viewing angle characteristic can be switched, wherein: one of the two substrates includes (i) a transparent electrode pattern in which transparent electrodes are provided in a striped manner and (ii) two wire electrodes, being provided in parallel with the transparent electrodes so as to correspond to respective of spaces in the transparent electrode pattern and such that the two wire electrodes and the respective of the spaces overlap each other, respectively; the other one of the two substrates includes (i) a transparent electrode pattern in which transparent electrodes are provided in a striped manner and (ii) two wire electrodes, being provided in parallel with transparent electrodes so as to correspond to respective of spaces in the transparent electrode pattern and such that the two wire electrodes and the respective of the spaces overlap each other, respectively; and the two substrates are provided so that their transparent electrodes are orthogonal to each other.

With the arrangements, the setting of the electric potentials of the wire electrodes in each substrate is changed. This makes it possible to more arbitrarily change a direction in which the liquid crystal molecules are tilted in the liquid crystal layer.

The viewing angle control panel of the present invention can be arranged such that: in each of the two substrates, (i) the two wire electrodes are a first wire electrode and a second wire electrode; and (ii) the first wire electrode and one side end part of the respective of the spaces overlap each other, and the second wire electrode and the other side end part of the respective of the spaces overlap each other. In this case, the viewing angle control panel of the present invention can also be arranged such that, in each of the two substrates, the two wire electrodes are provided in a single layer. Alternatively, the viewing angle control panel of the present invention can be arranged such that, in each of the two substrates, the two wire electrodes are provided in different layers, respectively. In this case, it is preferable that the first and second wire electrodes overlap each other. This allows the wire electrodes and the spaces in the transparent electrode pattern to overlap each other, in the respective substrate, thereby making it possible to prevent the liquid crystal layer from having the region in which no voltage is applied.

The viewing angle control panel of the present invention is a viewing angle control panel including two substrates facing each other and a liquid crystal layer provided between the substrates, a combination of the viewing angle control panel and a display panel constituting a liquid crystal display device in which a viewing angle characteristic can be switched, wherein: one of the two substrates includes (i) a transparent electrode pattern in which a transparent electrode is provided over the one of the two substrates and (ii) plural pairs of two wire electrodes that are provided, between the transparent electrode pattern and the liquid crystal layer, at intervals in a width direction orthogonal to a direction in which the wire electrodes extend and orthogonal to a normal direction of a substrate surface, two wire electrodes of each of the plural pairs being provided in parallel with each other and being close to or overlapping each other in the width direction; the other one of the two substrates includes (i) a transparent electrode pattern in which a transparent electrode is provided over the other one of the two substrates and (ii) plural pairs of two wire electrodes that are provided, between the transparent electrode pattern and the liquid crystal layer, at intervals in a width direction orthogonal to a direction in which the wire electrodes extend and orthogonal to a normal direction of a substrate surface, the two wire electrodes of each of the plural pairs being provided in parallel with each other and being close to or overlapping each other in the width direction; and the two substrates are provided so that their wire electrodes are orthogonal to each other.

With the arrangement, it is possible, by changing the setting of the electric potentials of the wire electrodes included by the respective substrates, to more arbitrarily change a direction in which the liquid crystal molecules are tilted in the liquid crystal layer.

The viewing angle control panel of the present invention can be arranged such that, in each of the two substrates, the two wire electrodes of each of the plural pairs are provided in a single layer. Alternatively, the viewing angle control panel of the present invention can be arranged such that, in each of the two substrates, the two wire electrodes of each of the plural pairs are provided in different layers, respectively. In this case, it is preferable that the two wire electrodes include a part where they overlap each other and a part where they do not overlap each other.

With the viewing angle control panel, setting of electric potentials, applied to the two wire electrodes in each of the plural pairs included by the two substrates, is changed such that a direction in which visibility of the liquid crystal display device is limited can be switched.

The viewing angle control panel of the present invention can be arranged such that a vertically-aligned negative liquid crystal is adopted as the liquid crystal display layer. Also, the viewing angle control panel of the present invention can be arranged such that the wire electrodes have a light transmitting property. Also, the viewing angle control panel of the present invention can be arranged so as to include two polarization plates between which the two substrates are sandwiched.

The viewing angle control panel of the present invention can be also described as a viewing angle control panel including two substrates facing each other and liquid crystal layer provided between the substrates, a combination of the viewing angle control panel and a display panel constituting a liquid crystal display device in which a viewing angle characteristic can be switched, wherein: one of the two substrates includes a counter electrode pattern in which a counter electrode is provided over the one of the two substrates; and the other one of the two substrates includes (i) a transparent electrode pattern in which transparent electrodes are provided in a striped manner and (ii) a first wire electrode and a second wire electrode, provided in parallel with the transparent electrodes so as to correspond to respective of spaces between the transparent electrodes in the transparent electrode pattern and such that the first and second wire electrodes and the respective of the spaces overlap each other, respectively.

The viewing angle control panel of the present invention can be also described as a viewing angle control panel including two substrates facing each other and a liquid crystal layer provided between the substrates, a combination of the viewing angle control panel and a display panel constituting a liquid crystal display device in which a viewing angle characteristic can be switched, wherein: one of the two substrates includes a counter electrode pattern in which a counter electrode is provided over the one of the two substrates; and the other one of the two substrates includes (i) a transparent electrode pattern in which transparent electrodes are provided in a striped manner and (ii) plural pairs of two wire electrodes that are provided between the counter electrode pattern and the transparent electrode pattern, two wire electrodes of each of the plural pairs being provided in parallel with each other and being close to or overlapping each other in a width direction orthogonal to a direction in which the wire electrodes extend and orthogonal to a normal direction of a substrate surface.

The viewing angle control panel of the present invention can be also described as a viewing angle control panel including two substrates facing each other and a liquid crystal layer provided between the substrates, a combination of the viewing angle control panel and a display panel constituting a liquid crystal display device in which a viewing angle characteristic can be switched, wherein: one of the two substrates includes (i) a transparent electrode pattern in which transparent electrodes are provided in a striped manner and (ii) first and second wire electrodes, provided in parallel with the transparent electrodes so as to correspond to respective of spaces between the transparent electrodes in the transparent electrode pattern and such that the first and second wire electrodes and the respective of the spaces overlap each other, respectively; and the other one of the two substrates includes (i) a transparent electrode pattern in which transparent electrodes are provided in a striped manner and (ii) first and second wire electrodes, provided in parallel with the transparent electrodes so as to correspond to respective of spaces between the transparent electrodes in the transparent electrode pattern and such that the first and second wire electrodes and the respective of the spaces overlap each other, respectively; and the two substrates are provided so that their transparent electrodes are orthogonal to each other.

The viewing angle control panel of the present invention can be also described as a viewing angle control panel including two substrates facing each other and a liquid crystal layer provided between the substrates, a combination of the viewing angle control panel and a display panel constituting a liquid crystal display device in which a viewing angle property can be switched, wherein: one of the two substrates includes (i) a transparent electrode pattern in which a transparent electrode is provided over the one of the two substrates and (ii) plural pairs of two wire electrodes that are provided between the transparent electrode pattern and the liquid crystal layer, two wire electrodes of each of the plural pairs being provided in parallel with each other and being close to or overlapping each other in a given direction parallel to a substrate surface; the other one of the two substrates includes (i) a transparent electrode pattern in which a transparent electrode is provided over the other one of the two substrates and (ii) plural pairs of two wire electrodes that are provided between the transparent electrode pattern and the liquid crystal layer, two wire electrodes of each of the plural pairs being provided in parallel with each other and being close to or overlapping each other in a given direction parallel to a substrate surface; and the two substrates are provided so that their wire electrodes are orthogonal to each other.

The liquid crystal display device of the present invention includes the viewing angle control panel and a display panel.

Thus, with the viewing angle control panel of the present invention, it is possible to cause an equipotential line in the liquid crystal layer to be changed in the vicinities of the edges of each transparent electrode. That is, it is possible, by changing the setting of the electric potentials of the wire electrodes, to change a direction in which the liquid crystal molecules are tilted. Also, it is possible, by setting the voltage between the transparent electrodes and the counter electrodes, to control an angle at which the liquid crystal molecules are tilted. This makes it possible to change (switch) a visibility limitation direction occurred when the viewing angle characteristic is a narrow viewing angle characteristic.

### BRIEF DESCRIPTION OF DRAWINGS

FIG. 1 is a cross sectional view showing an arrangement of a liquid crystal display device in accordance with first Embodiment of the present invention.

FIG. 2 is a perspective plane view showing a main arrangement of a viewing angle control panel in accordance with first Embodiment of the present invention.

FIG. 3 is a cross sectional view showing one configuration example of the liquid crystal display device of the present invention.

FIG. 4 is a cross sectional view showing a state of a liquid crystal layer (a state of a liquid crystal layer occurred when no voltage is applied) in accordance with first Embodiment of the present invention.

FIG. 5 is a cross sectional view showing a state of the liquid crystal layer (a state of the liquid crystal layer occurred when visibility is available at a six o'clock direction) in accordance with first Embodiment of the present invention.

FIG. 6 is a cross sectional view showing a state of the liquid crystal layer (a state of the liquid crystal layer occurred when the visibility is available at a twelve o'clock direction) in accordance with first Embodiment of the present invention.

FIG. 7 is a cross sectional view showing a state of the liquid crystal layer (a state of the liquid crystal layer occurred when the visibility is available at a wide viewing angle) in accordance with first Embodiment of the present invention.

FIG. 8 is a perspective view explaining directions in which the liquid crystal display device of the present invention is viewed.

FIG. 9 is a plane view explaining the directions in which the liquid crystal display device of the present invention is viewed.

FIG. 10 is a cross sectional view showing a modification example of a first substrate included by the viewing angle control panel in accordance with first Embodiment of the present invention.

FIG. 11 is a cross sectional view showing a modification example of the first substrate included by the viewing angle control panel in accordance with first Embodiment of the present invention.

FIG. 12 is a cross sectional view showing a modification example of the first substrate included by the viewing angle control panel in accordance with first Embodiment of the present invention.

FIG. 13 is a cross sectional view showing a modification example of the viewing angle control panel in accordance with first Embodiment of the present invention.

FIG. 14 is a cross sectional view showing a modification example of the viewing angle control panel in accordance with first Embodiment of the present invention.

FIG. 15 is a cross sectional view showing a modification example of the viewing angle control panel in accordance with first Embodiment of the present invention.

FIG. 16 is a cross sectional view showing a main arrangement of a viewing angle control panel in accordance with second Embodiment of the present invention.

FIG. 17 shows an arrangement of a viewing angle control panel in accordance with third Embodiment of the present invention. FIG. 17(a) is a plane view showing the arrangement of the viewing angle control panel. FIG. 17(b) is a cross sectional view of the viewing angle control panel shown in FIG. 17(a).

FIG. 18 is a cross sectional view showing a modification example of a first substrate included by the viewing angle control panel in accordance with third Embodiment of the present invention.

FIG. 19 is a cross sectional view showing a modification example of the first substrate included by the viewing angle control panel in accordance with third Embodiment of the present invention.

FIG. 20 is a cross sectional view showing a modification example of the first substrate included by the viewing angle control panel in accordance with third Embodiment of the present invention.

FIG. 21 is a cross sectional view showing a modification example of the first substrate included by the viewing angle control panel in accordance with third Embodiment of the present invention.

FIG. 22 is a cross sectional view showing a modification example of the viewing angle control panel in accordance with third Embodiment of the present invention.

FIG. 23 is a cross sectional view showing a modification example of the viewing angle control panel in accordance with third Embodiment of the present invention.

FIG. 24 shows an arrangement of a viewing angle control panel in accordance with fourth Embodiment of the present invention. FIG. 24(a) is a plane view of the viewing angle control panel. FIG. 24(b) is a cross sectional view of the viewing angle control panel shown in FIG. 24(a).

FIG. 25 is a cross sectional view showing a modification example of the viewing angle control panel in accordance with fourth Embodiment of the present invention.

FIG. 26 is a cross sectional view showing a modification example of the viewing angle control panel in accordance with fourth Embodiment of the present invention.

FIG. 27 is a cross sectional view showing a modification example of the viewing angle control panel in accordance with fourth Embodiment of the present invention.

FIG. 28 is a plane view showing an arrangement of a viewing angle control panel in accordance with fifth Embodiment of the present invention.

FIG. 29 is a cross sectional view taken on a line A of FIG. 28.

FIG. 30 is a cross sectional view taken on a line B of FIG. 28.

FIG. 31 is a plane view showing a modification example of the viewing angle control panel in accordance with fifth Embodiment of the present invention.

FIG. 32 is a cross sectional view of a first substrate of the viewing angle control panel shown in FIG. 31.

FIG. 33 is a cross sectional view of a second substrate of the viewing angle control panel shown in FIG. 31.

FIG. 34 is a plane view showing an arrangement of a viewing angle control panel in accordance with sixth Embodiment of the present invention.

FIG. 35 is a cross sectional view taken on a line AA′ of FIG. 34.

FIG. 36 is a plane view showing a modification example of the viewing angle control panel in accordance with sixth Embodiment of the present invention.

FIG. 37 is a cross sectional view of a first substrate of the viewing angle control panel shown in FIG. 36.

FIG. 38 is a cross sectional view of a second substrate of the viewing angle control panel shown in FIG. 36.

### REFERENCE SIGNS LIST

1. Liquid crystal display device
2. Viewing angle control panel
4. First substrate
5. Liquid crystal layer
6. Second substrate
10. Display panel
41. Glass substrate
43. Insulating film
45. Vertical alignment film
48. Wire electrode pattern
48a through 48f. Wire electrodes
49, 49x and 49y. Transparent electrode pattern
49a through 49d. Transparent electrodes
51x through 51z. Spaces in a transparent electrode pattern
53. Insulating film
54. Insulating film
58. First wire electrode pattern
61. Glass substrate
62. Counter electrode Pattern
63. Vertical alignment film
66. Insulating film
68. Second wire electrode pattern
143x and 143y. Insulating layers
153x and 153y. Insulating layers
154x and 154y. Insulating layers
166a through 166d. Insulating layers

### DESCRIPTION OF EMBODIMENTS

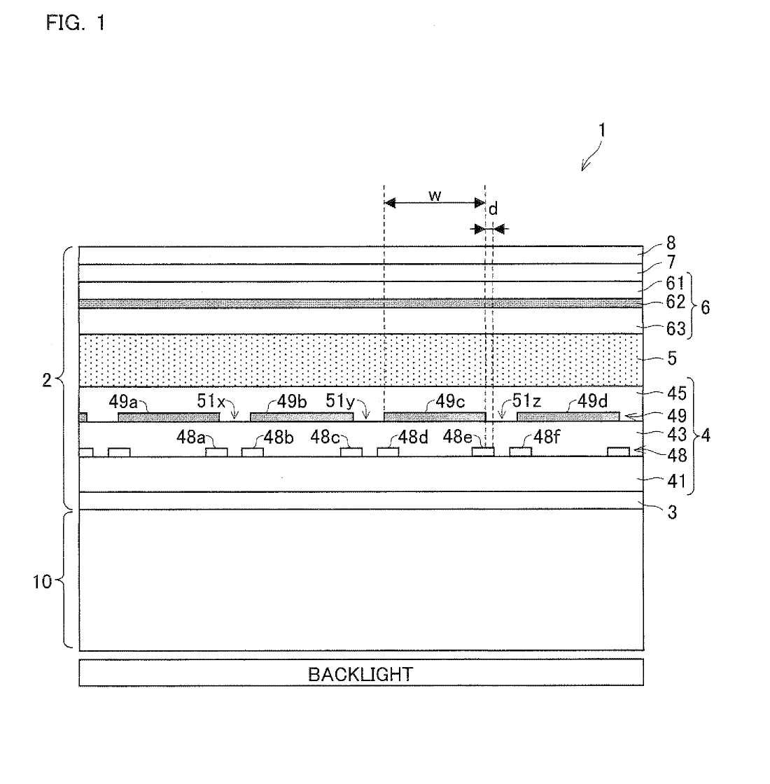

One embodiment of the present invention is described below with reference to FIGS. 1 through 26. FIG. 3 is a cross sectional view showing an arrangement of a liquid crystal display device of the present embodiment. As shown in FIG. 3, a liquid crystal display device 1 of the present embodiment includes a viewing angle control panel 2, a display panel 10, and a backlight. The viewing angle control panel 2 includes a polarization plate 3, a second substrate 4, a liquid crystal layer 5, a first substrate 6, a wave plate 7 (e.g., a C plate), and a polarization plate 8, which are sequentially provided from a backlight side in this order. The polarization plates 3 and 8 are positioned such that their light transmittance axes are orthogonal to each other.

The display panel 10 can be provided closer to the backlight. Alternatively, the viewing angle control panel 2 can be provided closer to the backlight. The liquid crystal display device of the present embodiment is not limited to a transmissive liquid crystal display device. Alternatively, the liquid crystal display device of the present embodiment can be a reflective or semi-transmissive liquid crystal display device.

### First Embodiment

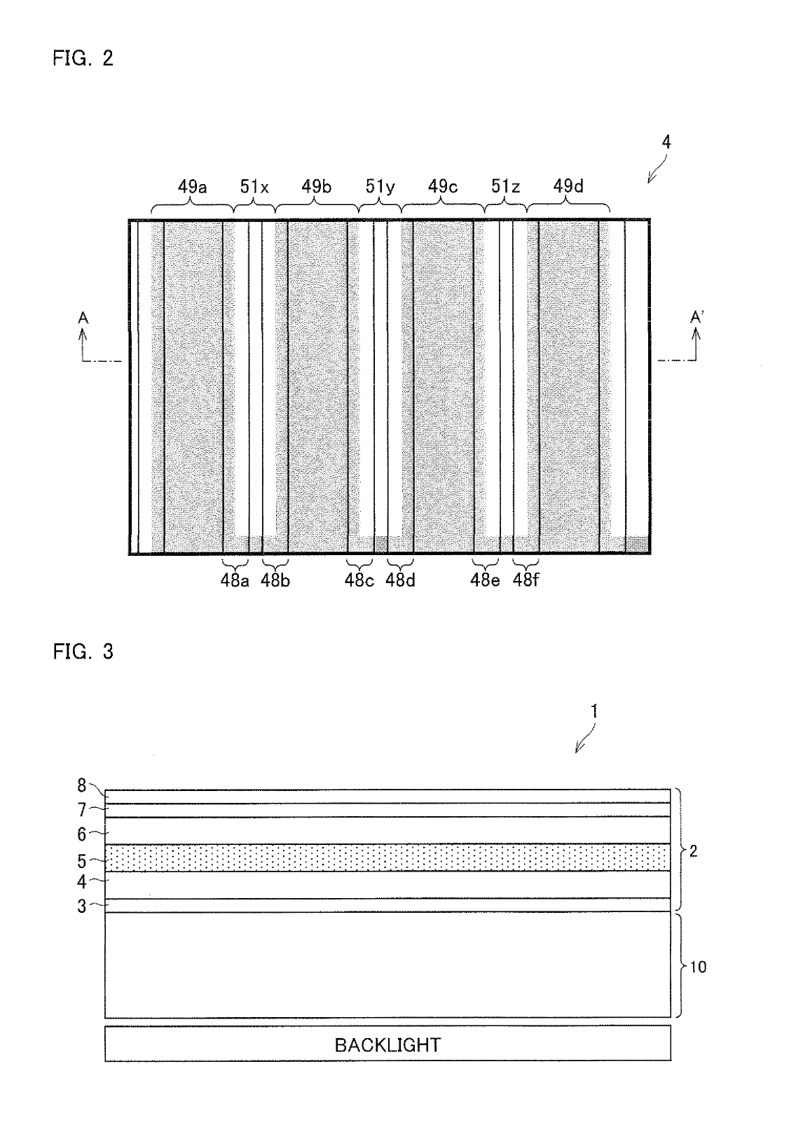

FIG. 1 is a cross sectional view of a liquid crystal display device 1 of the present embodiment, showing a partial arrangement where a second substrate 4, a liquid crystal layer 5, and a first substrate 6 are included. FIG. 2 is a perspective plane view of the liquid crystal display device 1 of the present embodiment, showing the partial arrangement shown in FIG. 1. As shown in FIGS. 1 and 2, the second substrate 4 includes a glass substrate 41, a wire electrode pattern 48, an insulating film 43, a transparent electrode pattern 49, and a vertical alignment film 45. Provided on the glass substrate 41 is the wire electrode pattern 48 in which wire electrodes (e.g., wire electrodes 48a through 48f) are provided in a striped manner. The insulting film 43 is provided so as to cover the wire electrode pattern 48. Provided on the insulating film 43 is the transparent electrode pattern in which transparent electrodes (e.g., transparent electrodes 49a through 49d), provided in parallel with the wire electrodes, respectively, are provided in a striped manner. The vertical alignment film 45 is provided so as to cover the transparent electrode pattern 49. A transparent electrode (the transparent pattern 49) is made of a material, having a light transmitting property, such as ITO. A wire electrode (the wire electrode pattern 48) can be made of a material having a light transmitting property or a material having no light transmitting property.

Two wire electrodes (a first wire electrode and a second wire electrode) are provided for a space between neighboring two transparent electrodes. Specifically, in a case where transparent electrodes 49a through 49d are successively provided in a striped manner, the wire electrodes 48a and 48b are provided as follows. That is, the wire electrode 48a (first wire electrode) extends in parallel with the transparent electrode 49a so that the wire electrode 48a and respective of (i) a left end part of a space 51x between the adjacent transparent electrodes 49a and 49b and (ii) a part (a right end part) of the transparent electrode 49a overlap each other. The wire electrode 48b (second wire electrode) extends in parallel with the transparent electrode 49b so that the wire electrode 48b and respective of (i) a right end part of the space 51x and (ii) a part (a left end part) of the transparent electrode 49b overlap each other (see FIGS. 1 and 2). Also, the wire electrode 48c extends in parallel with the transparent electrode 49b so that the wire electrode 48c and respective of (i) a left end part of a space 51y between the adjacent transparent electrodes 49b and 49c and (ii) a part (a right end part) of the transparent electrode 49b overlap each other. The wire electrode 48d extends in parallel with the transparent electrode 49c so that the wire electrode 48d and respective of (i) a right end part of the space 51y and (ii) a part (a left end part) of the transparent electrode 49c overlap each other. Also, the wire electrode 48e extends in parallel with the transparent electrode 49c so that the wire electrode 48e and respective of (i) a left end part of a space 51z between two neighboring transparent electrodes 49c and 49d and (ii) a part (a right end part) of the transparent electrode 49c overlap each other. The wire electrode 48f extends in parallel with the transparent electrode 49d so that the wire electrode 48f and respective of (i) a right end part of the space 51z and (ii) a part (a left end part) of the transparent electrode 49d overlap each other.

The first substrate 6 includes a glass substrate 61, a counter electrode pattern 62, and a vertical alignment film 63. Provided on the glass substrate 61 is the counter electrode pattern 62 in which a counter electrode 64 is provided over the first substrate 6. The vertical alignment film 63 is provided so as to cover the counter electrode pattern 62. The counter electrode pattern 62 is made of a material, having a light transmitting property, such as ITO.

A negative liquid crystal is adopted as the liquid crystal layer 5. The liquid crystal layer 5 is provided between the vertical alignment film 45 of the second substrate 4 and the vertical alignment film 63 of the first substrate 6. This causes the liquid crystal layer 5 to be vertically aligned.

As such, in the arrangement shown in FIG. 1, (i) the counter electrode pattern 62 is provided in the first substrate 6, and (ii) the wire electrode pattern 48 and the transparent electrode pattern 49 are provided in the second substrate 4. In the wire electrode pattern 48, two wire electrodes (e.g., the wire electrodes 48b and 48c) are provided so as to correspond to one transparent electrode (e.g., the transparent electrode 49b). For example, the wire electrode 48b is provided so as to bridge a left edge of the transparent electrode 49b, and the wire electrode 48c is provided so as to bridge a right edge of the transparent electrode 49b. Also, the wire electrode 48d is provided so as to bridge a left edge of the transparent electrode 49c, and the wire electrode 48e is provided so as to bridge a right edge of the transparent electrode 49c.

The second substrate 4 includes the transparent electrode pattern 49 and the wire electrode pattern 48 which are arranged in the manner described above, while the counter electrode 62 includes the first substrate 6. This allows an equipotential line in the liquid crystal layer 5 to be changed in the vicinity of two edges of each transparent electrode (edges extending in a direction in which each transparent electrode extends). This, in turn, makes it possible to arbitrarily control a direction in which liquid crystal molecules are tilted in the liquid crystal layer 5.

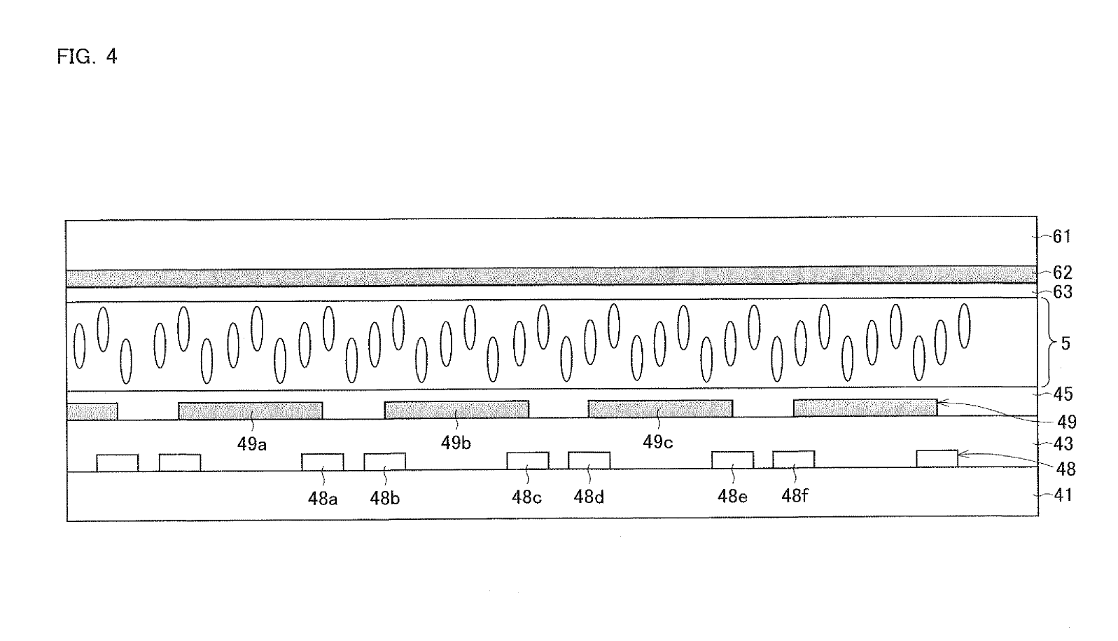

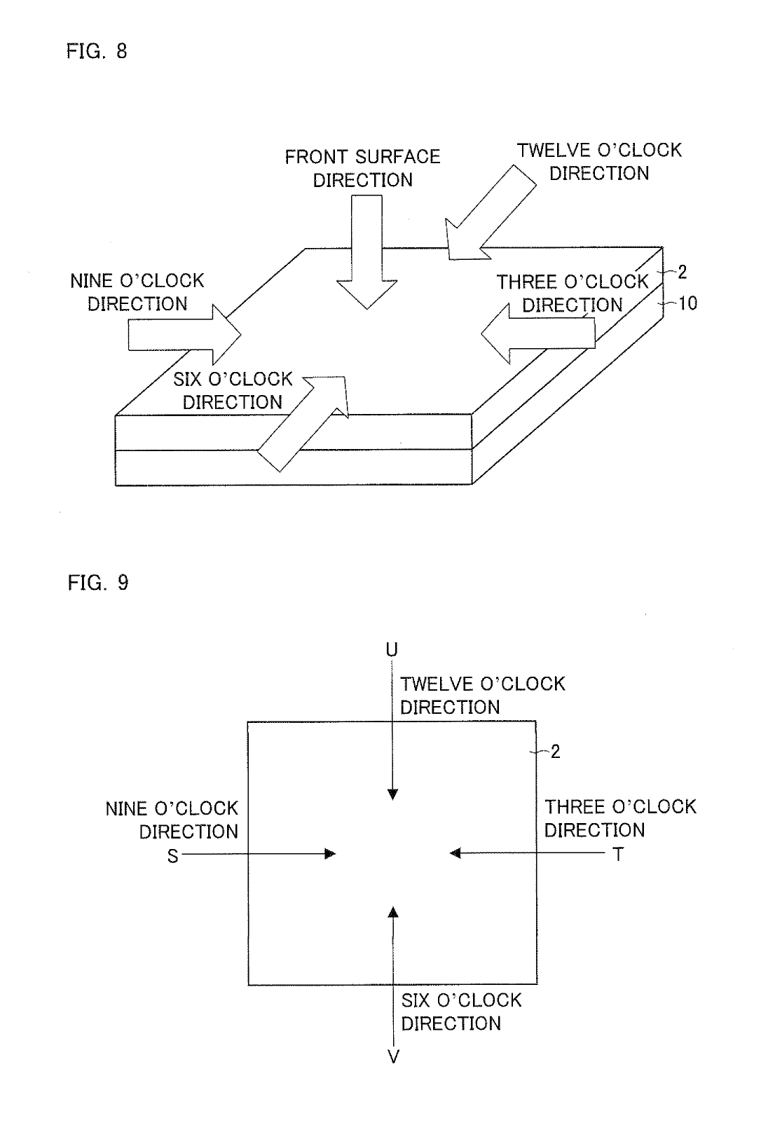

With reference to FIGS. 4 through 7, the following description deals with how a viewing angle characteristic of the liquid crystal display device shown in FIGS. 1 through 3 is switched. Note that the following description deals with the following five directions as visible directions or visibility limitation directions (invisible directions). Specifically, a front surface direction, a three o'clock direction, a six o'clock direction, a nine o'clock direction, and a twelve o'clock direction, in the viewing angle control panel 2 (or the display panel 10) (see FIGS. 8 and 9).

In the viewing angle control panel 2 of the present embodiment, electric potentials of the wire electrodes 48a through 48d are controlled while the counter electrode pattern 62 and the transparent electrode pattern 49 are given prescribed electric potentials, respectively (see FIG. 1). This causes the viewing angle characteristic of the liquid crystal display device 1 to be switched.

In the following description, it is supposed that electric potentials of the counter electrode, the transparent electrode, and the wire electrodes 48b through 48e are Vcom, Vseg, and Vb through Ve, respectively. It is also supposed that control is carried out so that Vseg, Vb, Vc, Vd, and Ve are all greater than Vcom or are all smaller than Vcom. FIG. 4 shows a state of the liquid crystal layer 5 occurred when no voltage is applied to the liquid crystal layer 5.

First, the following description deals with a case in which control is carried out so that

|Vcom−Vseg|>|Vcom−Vb|

|Vcom−Vseg|<|Vcom−Vc|

|Vcom−Vseg|>|Vcom−Vd|

|Vcom−Vseg|<|Vcom−Ve|

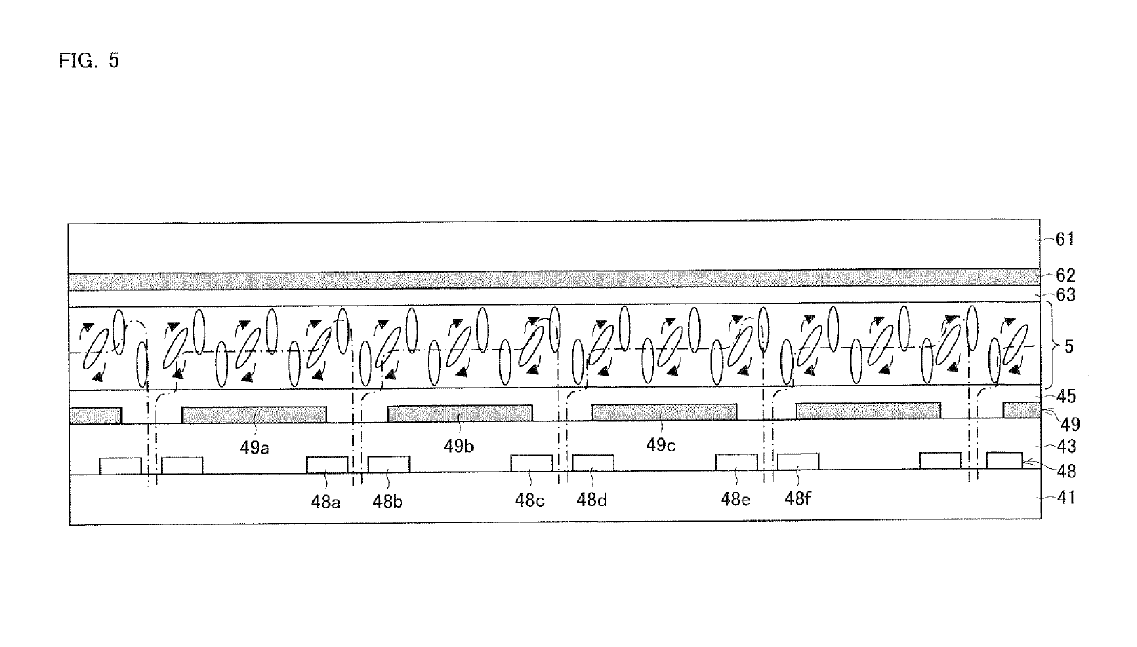

are satisfied. In this case, an equipotential line around the transparent electrode 49b, for example, (i) falls in the vicinity of the left edge of the transparent electrode 49b, due to the wire electrode 48b, and (ii) rises in the vicinity of the right edge of the transparent electrode 49b, due to the wire electrode 48c. Likewise, an equipotential line around the transparent electrode 49c (i) falls in the vicinity of the left edge of the transparent electrode 49c, due to the wire electrode 48d, and (ii) rises in the vicinity of the right edge of the transparent electrode 49c, due to the wire electrode 48e. This causes the liquid crystal layer 5 to have an equipotential line shown by a dash line in FIG. 5, thus causing liquid crystal molecules shown in FIG. 4 to be tilted in a direction indicated by an arrow in FIG. 5. The alignment of the molecules of the liquid crystal layer 5 shown in FIG. 5 causes the liquid crystal device 1 to have a narrow viewing angle characteristic. This allows the liquid crystal device 1 to be visible solely in the six o'clock direction and in the front surface direction.

Also, the following description deals with a case in which control is carried out so that

|Vcom−Vseg|<|Vcom−Vb|

|Vcom−Vseg|>|Vcom−Vc|

|Vcom−Vseg|<|Vcom−Vd|

|Vcom−Vseg|>|Vcom−Ve|

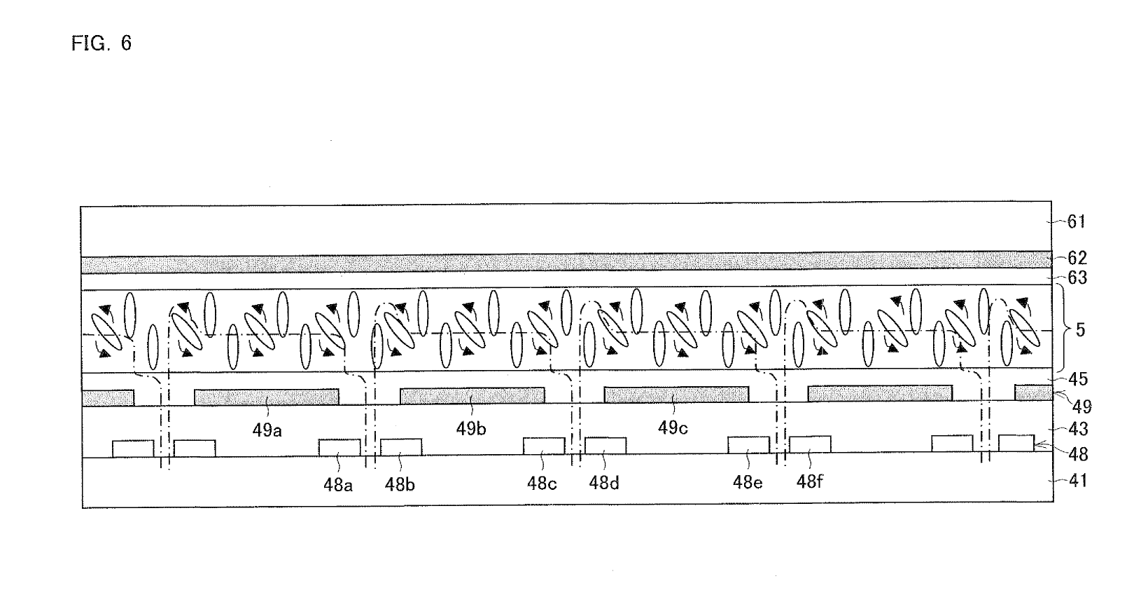

are satisfied. In this case, an equipotential line around the transparent electrode 49b, for example, (i) rises in the vicinity of the left edge of the transparent electrode 49b, due to the wire electrode 48b, and (ii) falls in the vicinity of the right edge of the transparent electrode 49b, due to the wire electrode 48c. Likewise, an equipotential line around the transparent electrode 49c (i) rises in the vicinity of the left edge of the transparent electrode 49c, due to the wire electrode 48d, and (ii) falls in the vicinity of the right edge of the transparent electrode 49c, due to the wire electrode 48e. This causes the liquid crystal layer 5 to have an equipotential line shown by a dash line in FIG. 6, thus causing liquid crystal molecules shown in FIG. 4 to be tilted in a direction indicated by an arrow in FIG. 6. The alignment of the molecules of the liquid crystal layer 5 shown in FIG. 6 causes the liquid crystal display device 1 to have a narrow viewing angle characteristic. This allows the liquid crystal display device 1 to be visible solely in the twelve o'clock direction and in the front surface direction.

Also, the following description deals with a case in which control is carried out so that

|Vcom−Vseg|<<|Vcom−Vb|

|Vcom−Vseg|>>|Vcom−Vc|

|Vcom−Vseg|>>|Vcom−Vd|

|Vcom−Vseg|<<|Vcom−Ve|

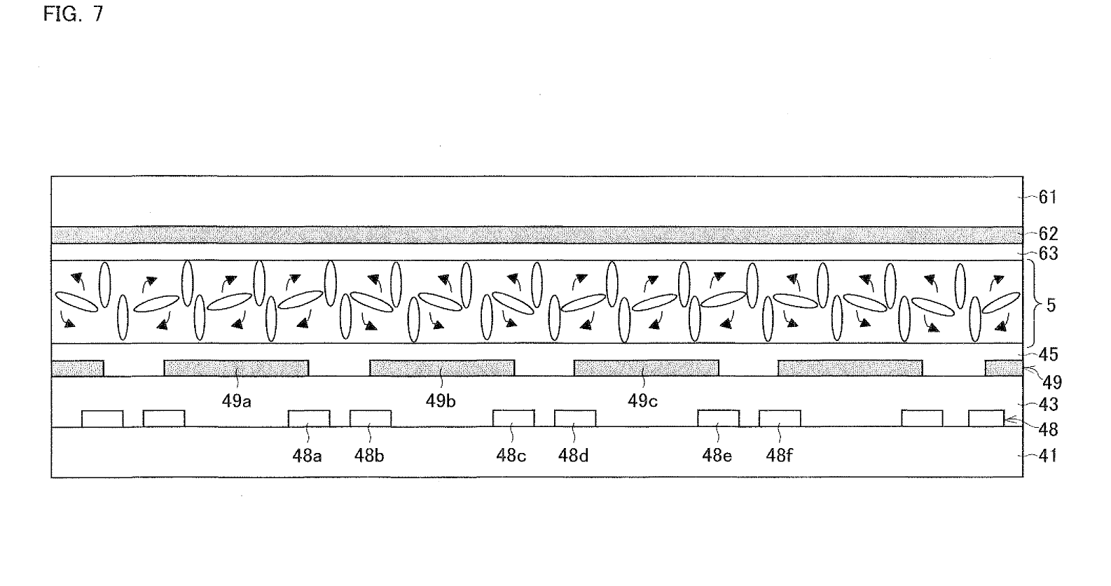

are satisfied. In this case, liquid crystal molecules are tilted in a direction indicated by an arrow in FIG. 7. The liquid crystal molecules are tilted in the same direction as shown in FIG. 5, but they are tilted at a larger angle. This causes the liquid crystal molecules of the liquid crystal layer 5 to be in a state shown in FIG. 7, thereby making it possible to cause the liquid crystal display device 1 to have a wide viewing angle characteristic (i.e., the liquid crystal display device 1 is visible in all directions).

With the present embodiment, it is preferable that each transparent electrode have a given width or less. For example, each of the transparent electrodes has a width w of 150 μm or less (see FIG. 1). Also, it is preferable that each wire electrode and the space between neighboring transparent electrodes overlap each other by a given area or more. This allows the equipotential line in the liquid crystal layer 5 to be changed with accuracy in the vicinity of the edges of each transparent electrode. In view of the circumstances, an overlapping width d of the wire electrode 48e and the space 51z is set to 5 μm or more, in the liquid crystal display device 1 shown in FIG. 1.

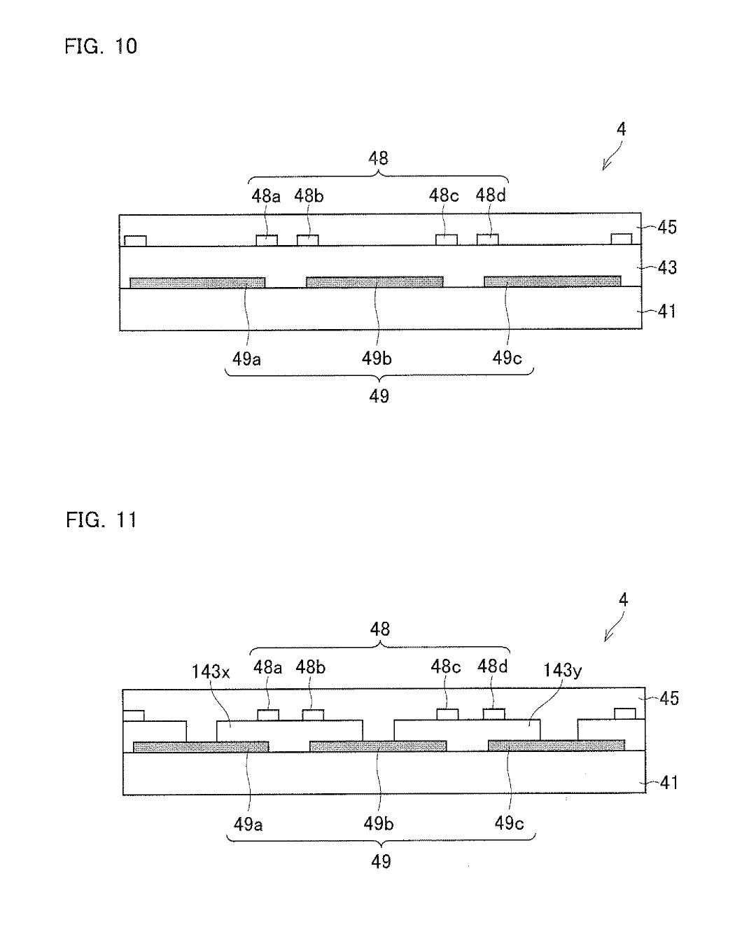

In the arrangement shown in FIG. 1, the wire electrode pattern 48 is provided in a layer below a layer in which the transparent electrode pattern 49 is provided (i.e., the wire electrode pattern 48 is provided closer to the backlight). However, the present embodiment is not limited to this. Alternatively, another viewing angle control panel 2 of the present embodiment can be arranged such that the wire electrode pattern 48 is provided in a layer above a layer in which the transparent electrode pattern 49 is provided (i.e., the wire electrode pattern 48 is provided closer to the first substrate 6) (see FIG. 10). In this case, provided on the glass substrate 41 is the transparent electrode pattern 49 in which the transparent electrodes (e.g., the transparent electrodes 49a through 49c) are provided in a striped manner. The insulating film 43 is provided so as to cover the transparent electrode pattern 49. Provided on the insulating film 43 is the wire electrode pattern 48 in which the wire electrodes (e.g., the wire electrodes 48a through 48d), provided in parallel with the transparent electrodes, respectively, are provided in a striped manner. The vertical alignment film 45 is provided so as to cover the wire electrode pattern 48. A positional relation between respective of the wire electrodes and respective of the transparent electrodes is the same as shown in FIG. 1. Note, however, that a plurality of insulating layers can be independently provided, instead of the single insulating film 43 (see FIG. 11). For example, insulating layers 143x and 143y are independently provided on the transparent electrode pattern 49. The wire electrodes 48a and 48b are provided on the insulating layer 143x, and the wire electrodes 48c and 48d are provided on the insulating layer 143y.

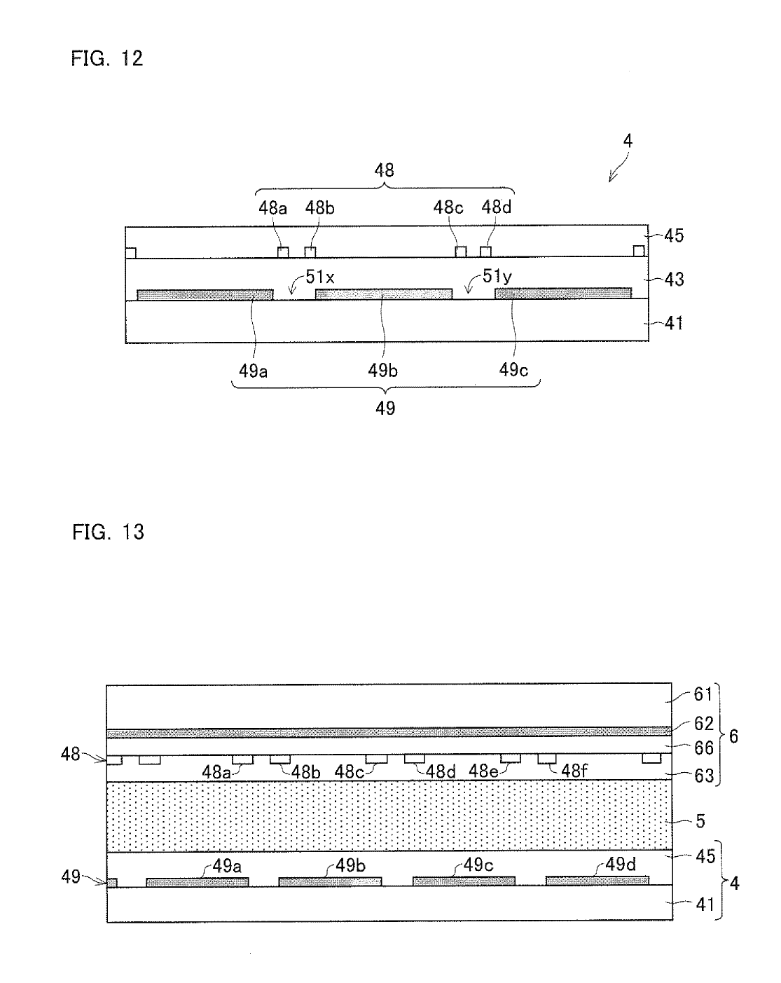

Also, the arrangement shown in FIG. 1 deals with the case where a wire electrode and a corresponding transparent electrode overlap each other. However, the present embodiment is not limited to this. Alternatively, two wire electrodes can be arranged so that respective of the two wire electrodes and a space between neighboring transparent electrodes overlap each other, but respective of the two wire electrodes and respective of the neighboring transparent electrodes do not overlap each other. For example, the wire electrodes 48a, 48b, 48c, and 48d are provided as follows, in the arrangement in which (i) the transparent electrode pattern 49, where the transparent electrodes 49a through 49c are provided in a striped manner, is provided on the glass substrate 41, (ii) the insulating film 43 is provided so as to cover the transparent electrodes pattern 49, and (iii) the wire electrode pattern 48, where the wire electrodes 48a through 48d provided in parallel with the transparent electrodes, respectively, are provided in a striped manner, is provided on the insulating film 43 (see FIG. 12). Specifically, (i) respective of the wire electrodes 48a and 48b and (ii) the space 51x between the neighboring transparent electrodes 49a and 49b overlap each other. However, (i) the respective of the wire electrodes 48a and 48b and (ii) respective of the neighboring transparent electrodes 49a and 49b do not overlap each other. Also, (i) respective of the wire electrodes 48c and 48d and (ii) the space 51y between the neighboring transparent electrodes 49b and 49c overlap each other. However, (i) the respective of the wire electrodes 48c and 48d and (ii) respective of the transparent electrodes 49b and 49c do not overlap each other.

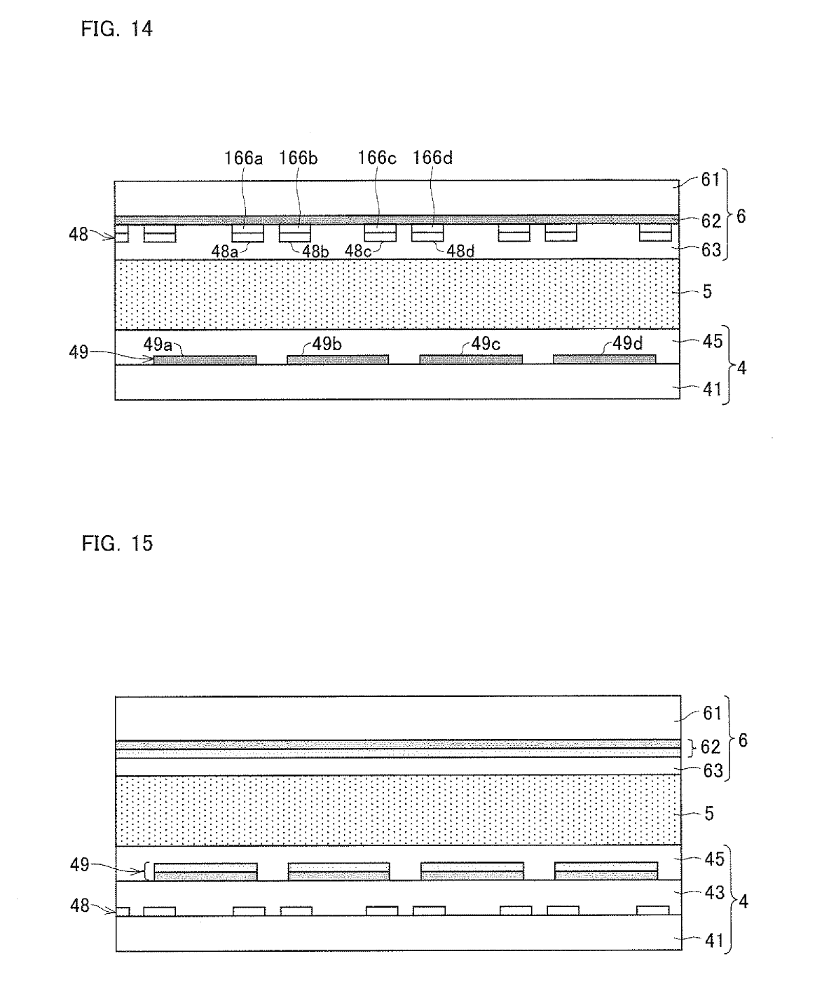

Further, the arrangement shown in FIG. 1 deals with the case where the wire electrode pattern 48 is provided in the second substrate 4. However, the present embodiment is not limited to this. Alternatively, a further viewing angle control panel 2 of the present embodiment can be arranged such that a wire electrode pattern 48 is provided in the first substrate 6 (see FIG. 13). In the second substrate 4, in this case, the transparent electrode pattern 49 is provided on the glass substrate 41. In the transparent electrode pattern 49, the transparent electrodes (e.g., the transparent electrodes 49a through 49c) are provided in a striped manner. The vertical alignment film 45 is provided so as to cover the transparent electrode pattern 49. In the first substrate 6, the counter electrode pattern 62 is provided on the glass substrate 61. The insulting film 66 is provided so as to cover the counter electrode pattern 62. Provided on the insulting film 66 is the wire electrode pattern 48 in which the wire electrodes (e.g., the wire electrodes 48a through 48d), provided in parallel with the transparent electrodes, respectively, are provided in a striped manner. The vertical alignment film 63 is provided so as to cover the wire electrode pattern 48. A positional relation between respective of the wire electrodes and respective of the transparent electrodes is the same as shown in FIG. 1. Note, however, that insulating layers can be independently provided, instead of the insulating film 66 (see FIG. 14). For example, insulating layers 166a through 166d are independently provided on the counter electrode pattern 62. The wire electrode 48a through 48d are provided on the insulating layers 166a through 166d, respectively.

Furthermore, the arrangement shown in FIG. 1 deals with the case where each of the wire electrode pattern 48, the transparent electrode pattern 49, and the counter electrode pattern 62 is made of a single layer. However, the present embodiment is not limited to this. For example, still a further viewing angle control panel 2 of the present embodiment can be arranged such that (i) the transparent electrode pattern 49 (the transparent electrodes) is provided in multiple layers each made of a different material, and (ii) the counter electrode pattern 62 is provided in multiple layers each made of a different material (see FIG. 15).

### Second Embodiment

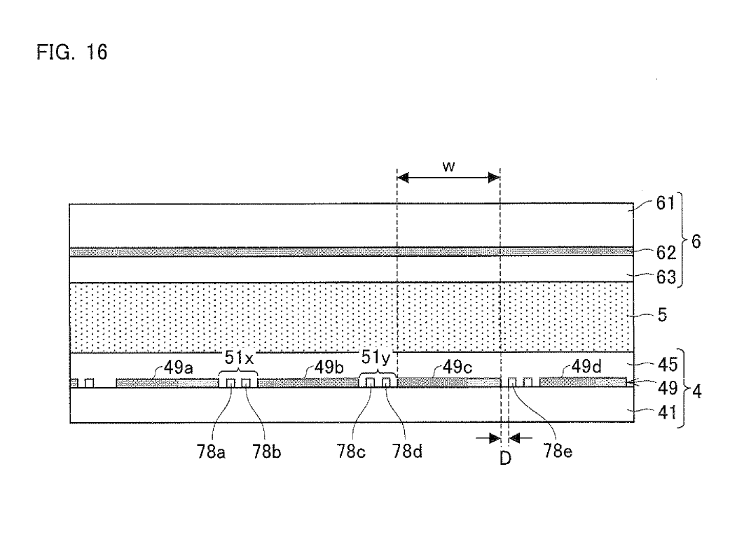

The arrangement shown in FIG. 1 deals with the case where a wire electrode pattern 48 and a transparent electrode pattern 49 are provided in different layers. However, the present embodiment is not limited to this. Alternatively, another viewing angle control panel 2 of the present embodiment can be arranged such that a wire electrode is provided in respective of spaces in a transparent electrode pattern 49 (see FIG. 16). In this case, a first substrate 6 has the same arrangement as shown in FIG. 1, whereas a second substrate 4 has an arrangement in which the transparent electrode pattern 49 is provided on a glass substrate 41. Transparent electrodes (e.g., transparent electrodes 49a through 49c) are provided in a striped manner in the transparent electrode pattern 49. Two wire electrodes are provided in respective of the spaces between neighboring wire electrodes. For example, wire electrodes 78a and 78b are provided in a space 51x between the neighboring transparent electrodes 49a and 49b, and wire electrodes 78c and 78d are provided in a space 51y between the neighboring transparent electrodes 49b and 49c. It is preferable that the wire electrode 78a be provided close to a right edge of the transparent electrode 49a, the wire electrode 78b be provided close to a left edge of the transparent electrode 49b, the wire electrode 78c be provided close to a right edge of the transparent electrode 49b, and the wire electrode 78d be provided close to a left edge of the transparent electrode 49c. A vertical alignment film 45 is provided so as to cover the transparent electrode pattern 49 and the wire electrodes (e.g., the wire electrodes 78a through 78d). Thus, the second substrate 4 includes the transparent pattern 49 and the wire electrodes arranged in the manner described above, while the first substrate 6 includes the counter electrode pattern 62. This allows an equipotential line in a liquid crystal layer 5 to be changed in the vicinity of two edges of each of the transparent electrodes (the edges extending in a direction in which each of the transparent electrodes extends). This, in turn, makes it possible to change (i) a direction in which liquid crystal molecules are tilted in the liquid crystal layer 5 and (ii) an angle (a degree of inclination) at which the liquid crystal molecules are tilted.

It is supposed, in the arrangement shown in FIG. 16, that (i) electric potentials of the counter electrode, a transparent electrode, and the wire electrodes 78b through 78e are indicated by Vcom, Vseg, and VB through VE, respectively, and (ii) control is carried out so that Vseg, VB, VC, VD, and VE are all greater than Vcom or are all smaller than Vcom.

First, the following description deals with a case in which control is carried out so that

|Vcom−Vseg|>|Vcom−VB|

|Vcom−Vseg|<|Vcom−VC|

|Vcom−Vseg|>|Vcom−VD|

|Vcom−Vseg|<|Vcom−VE|

are satisfied. In this case, the liquid crystal layer 5 becomes in a state as shown in FIG. 5. This causes a liquid crystal display device 1 to have a narrow viewing angle characteristic, in which the liquid crystal device 1 is visible solely in a six o'clock direction and in a front surface direction.

Also, the following description deals with a case in which control is carried out so that

|Vcom−Vseg|<|Vcom−VB|

|Vcom−Vseg|>|Vcom−VC|

|Vcom−Vseg|<|Vcom−VD|

|Vcom−Vseg|>|Vcom−VE|

are satisfied. In this case, the liquid crystal layer 5 becomes in a state as shown in FIG. 6. This causes the liquid crystal display device 1 to have a narrow viewing angle characteristic, in which the liquid crystal display device 1 is visible solely in a twelve o'clock direction and in the front surface direction.

Also, the following description deals with a case in which control is carried out so that

|Vcom−Vseg|<<|Vcom−VB|

|Vcom−Vseg|>>|Vcom−VC|

|Vcom−Vseg|>>|Vcom−VD|

|Vcom−Vseg|<<|Vcom−VE|

are satisfied. In this case, the liquid crystal layer 5 becomes in a state as shown in FIG. 7. This allows the liquid crystal display device 1 to have a wide viewing angle characteristic (i.e., the liquid crystal display device 1 is visible in all directions).

It is also preferable in the present embodiment that each transparent electrode have a given width or less. For example, the transparent electrode is set to have a width w of 150 μm or less in the arrangement shown in FIG. 16. Also, it is preferable that a distance (a gap) between respective neighboring ones of the transparent electrodes and the wire electrodes be a given distance or less. This allows the equipotential line in the liquid crystal layer 5 to be changed with accuracy in the vicinity of the edges of each of the transparent electrodes. For example, a distance D between the transparent electrode 49c and the wire electrode 78e is set to 5 μm or less in the arrangement shown in FIG. 16.

### Third Embodiment

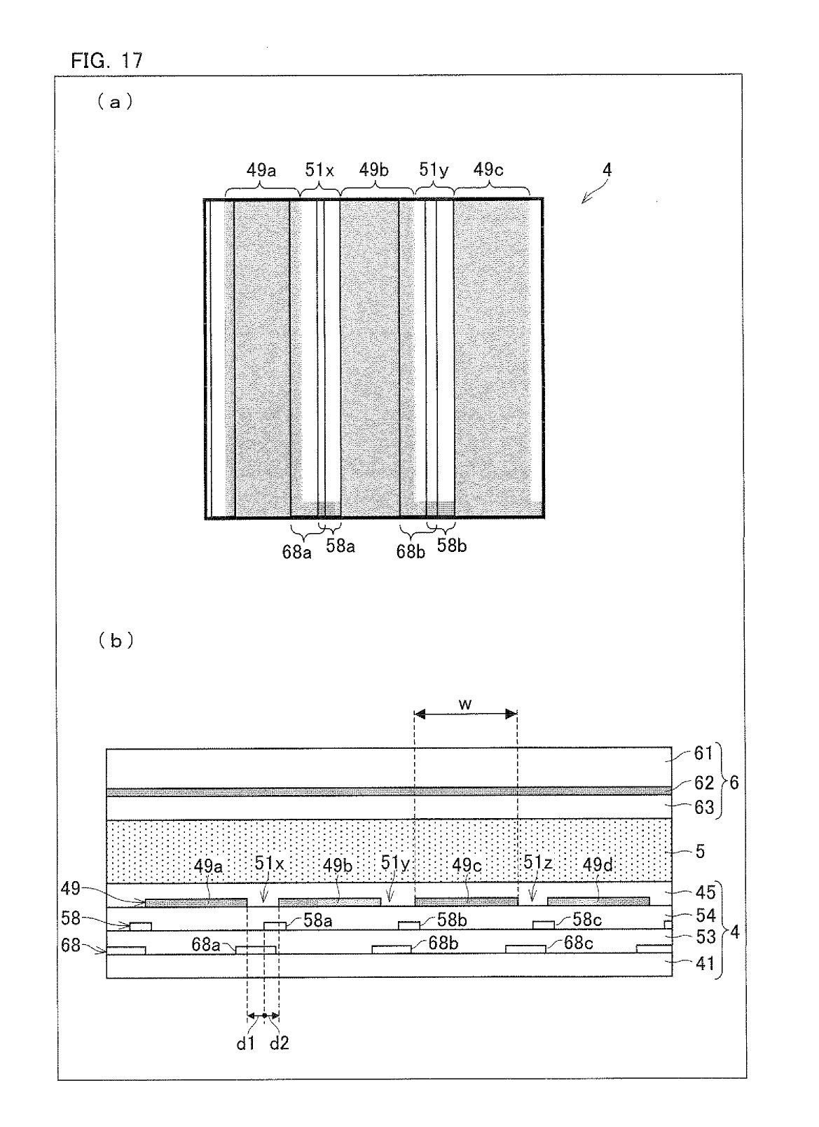

The arrangement shown in FIG. 1 deals with the case where wire electrodes are arranged in a single layer (i.e., wire electrodes are provided in a wire electrode pattern 48). However, the present embodiment is not limited to this. Alternatively, a further viewing angle control panel 2 of the present embodiment can be arranged such that a first wire electrode pattern 58 and a second wire electrode pattern 68 are provided so that wire electrodes are separately provided in two wire electrode patterns 58 and 68, respectively (see a plain view shown in 17(a), which is shown in the same way as FIG. 9, and a cross sectional view thereof shown in FIG. 17(b)). In this case, a first substrate 6 has the same arrangement as shown in FIG. 1, whereas a second substrate 4 has an arrangement in which the second wire electrode pattern 68 is provided on a glass substrate 41. Wire electrodes (e.g., wire electrodes 68a through 68c) are provided in a striped manner in the second wire electrode pattern 68. An insulating film 53 is provided so as to cover the second wire electrode pattern 68. Provided on the insulating film 53 is the first wire electrode pattern 58 in which wire electrodes (e.g., wire electrodes 58a through 58c) are provided in a striped manner. An insulating film 54 is provided so as to cover the first wire electrode pattern 58. Provided on the insulating film 54 is a transparent electrode pattern 49 in which transparent electrodes (e.g., transparent electrodes 49a through 49d), provided in parallel with the wire electrodes, respectively, are provided in a striped manner. A vertical alignment film 45 is provided so as to cover the transparent electrode pattern 49.

In the present embodiment, the wire electrode 68a extends in parallel with the transparent electrode 49a so that the wire electrode 68a and respective of (i) a left end part of a space 51x between the adjacent transparent electrodes 49a and 49b and (ii) a part (a right end part) of the transparent electrode 49a overlap each other. The wire electrode 58a extends in parallel with the transparent electrode 49b so that the wire electrode 58a and respective of (i) a right end part of the space 51x and (ii) a part (a left end part) of the transparent electrode 49b overlap each other (see FIGS. 17(a) and 17(b)). Also, the wire electrode 68b extends in parallel with the transparent electrode 49b so that the wire electrode 68b and respective of (i) a left end part of a space 51y between the two adjacent transparent electrodes 49b and 49c and (ii) a part (a right end part) of the transparent electrode 49b overlap each other. The wire electrode 58b extends in parallel with the transparent electrode 49c so that the wire electrode 58b and respective of (i) a right end part of the space 51y and (iv) a part (a left end part) of the transparent electrode 49c overlap each other. Also, the wire electrode 68c extends in parallel with the transparent electrode 49c so that the wire electrode 68c and respective of (i) a left end part of a space 51z between the two adjacent transparent electrodes 49c and 49d and (ii) a part (a right end part) of the transparent electrode 49c overlap each other. The wire electrode 58c extends in parallel with the transparent electrode 49d so that the wire electrode 58c and respective of (i) a right end part of the space 51z and (ii) a part (a left end part) of the transparent electrode 49d overlap each other. In other words, two wire electrodes (e.g., the wire electrodes 58a and 68b) are provided so as to correspond to one transparent electrode (e.g., the transparent electrode 49b). For example, the wire electrode 58a is provided so as to bridge a left edge of the transparent electrode 49b, and the wire electrode 68b is provided so as to bridge a right edge of the transparent electrode 49b. Also, the two wire electrodes 58b and 68c are provided so as to correspond to the transparent electrode 49c. The wire electrode 58b is provided so as to bridge a left edge of the transparent electrode 49c, and the wire electrode 68c is provided so as to bridge a right edge of the transparent electrode 49c. As such, while the first substrate 6 includes the counter electrode pattern 62, the second substrate 4 includes (i) the transparent electrode pattern 49 and (ii) the first wire electrode pattern 58 and the second wire electrode pattern 68, each arranged in the manner described above. This allows an equipotential line in a liquid crystal layer 5 to be changed in the vicinity of the two edges of each of the transparent electrodes (i.e., edges extending in a direction in which each of the transparent electrodes extend). This, in turn, makes it possible to change (i) a direction in which liquid crystal molecules are tilted in the liquid crystal layer 5 and (ii) an angle (a degree of inclination) at which the liquid crystal molecules are tilted.

It is supposed that electric potentials of the counter electrode, the transparent electrodes, the wire electrode 58a, the wire electrode 68b, the wire electrode 58b, and the wire electrode 68c are Vcom, Vseg, Vα, Vβ, Vγ, and Vδ, respectively. It is also supposed, in the arrangement shown in FIG. 17, that control is carried out so that Vseg, Vα, Vβ, Vγ, and Vδ are all greater than Vcom or are all smaller than Vcom.

The following description deals with a case in which control is carried out so that

|Vcom−Vseg|>|Vcom−Vα|

|Vcom−Vseg|<|Vcom−Vβ|

|Vcom−Vseg|>|Vcom−Vγ|

|Vcom−Vseg|<|Vcom−Vδ|

are satisfied. In this case, the liquid crystal layer 5 becomes in a state as shown in FIG. 5. This causes a liquid crystal display device 1 to have a narrow viewing angle characteristic, in which the liquid crystal display device 1 is visible solely in a six o'clock direction and in a front surface direction.

Also, the following description deals with a case in which control is carried out so that

|Vcom−Vseg|<|Vcom−Vα|

|Vcom−Vseg|>|Vcom−Vβ|

|Vcom−Vseg|<|Vcom−Vγ|

|Vcom−Vseg|>|Vcom−Vδ|

are satisfied. In this case, the liquid crystal layer 5 becomes in a state as shown in FIG. 6. This causes the liquid crystal display device 1 to have a narrow viewing angle characteristic, in which the liquid crystal display device 1 is visible solely in a twelve o'clock direction and in the front surface direction.

Also, the following description deals with a case in which control is carried out so that

|Vcom−Vseg|<<|Vcom−Vα|

|Vcom−Vseg|>>|Vcom−Vβ|

|Vcom−Vseg|>>|Vcom−Vγ|

|Vcom−Vseg|<<|Vcom−Vδ|

are satisfied. In this case, the liquid crystal layer 5 becomes in a state as shown in FIG. 7. This can cause the liquid crystal display device 1 to have a wide viewing angle characteristic (i.e., the liquid crystal display device 1 is visible in all directions).

In the arrangement shown in FIG. 17, it is preferable that the wire electrodes in the first wire electrode pattern 58 and the wire electrodes in the second wire electrode pattern 68 overlap each other, respectively. For example, a left end part of the wire electrode 58a in the first wire electrode pattern 58 and a right end part of the wire electrode 68a in the second wire electrode pattern 68 are arranged so as to overlap each other. Also, a left end part of the wire electrode 58b in the first wire electrode pattern 58 and a right end part of the wire electrode 68b in the second wire electrode pattern 68 are arranged so as to overlap each other. Also, a left part of the wire electrode 58c in the first wire electrode pattern 58 and a right part of the wire electrode 68c in the second wire electrode pattern 68 are arranged so as to overlap each other. This allows the wire electrodes and spaces in the transparent electrode pattern 49 to overlap each other, thereby making it possible to prevent the liquid crystal layer 5 from having a region to which no voltage is applied.

It is also preferable in the present embodiment that each transparent electrode have a given width or less. For example, each of the transparent electrodes has a width w of 150 μm or less (see FIG. 17). Also, it is preferable that each wire electrode and the space between adjacent electrodes overlap each other by a given area or more. This allows the equipotential line in the liquid crystal layer 5 to be changed with accuracy in the vicinity of the edges of each transparent electrode. As such, an overlapping width d1 (an actual overlapping width that excludes an overlapping width in which the wire electrode 68a and the wire electrode 58a overlap each other) of the wire electrode 68a and the space 51x between the adjacent transparent electrodes is set to 5 μm or more, and an overlapping width d2 of the wire electrode 58a and the space 51x is set to 5 μm or more (see FIG. 17).

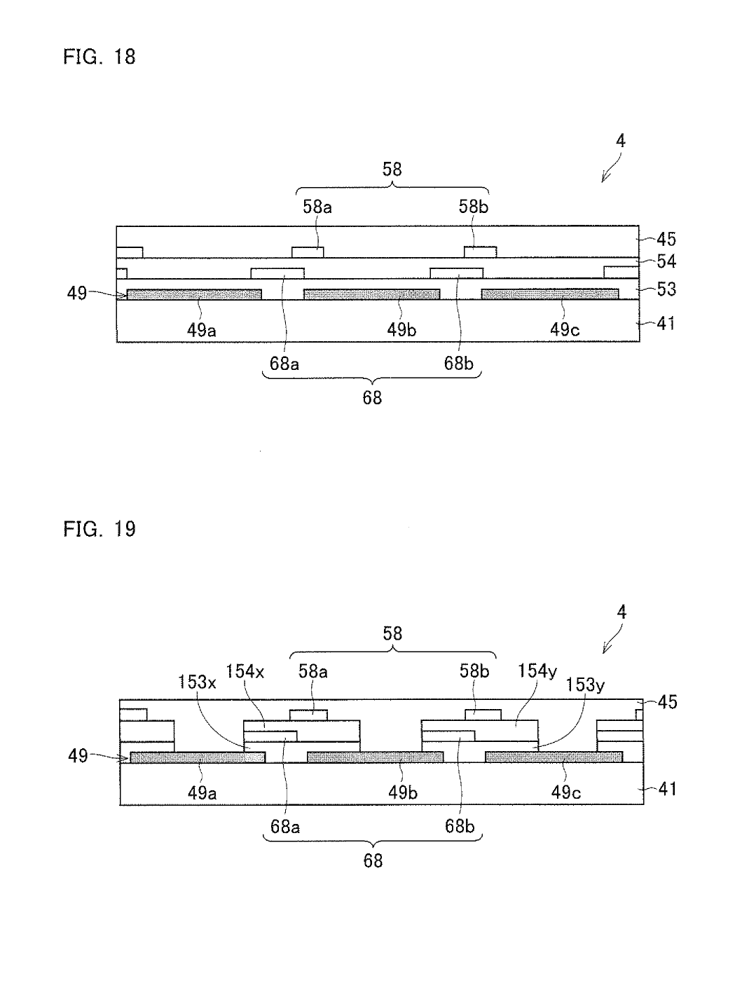

The arrangement shown in FIG. 17 deals with the case where the first wire electrode pattern 58 and the second wire electrode pattern 68 are provided in layers (i.e., layers provided closer to a backlight), respectively, that are provided below a layer in which the transparent electrode pattern 49 is provided. However, the present embodiment is not limited to this. Alternatively, still a further viewing angle control panel 2 of the present embodiment can be arranged such that a first wire electrode pattern 58 and a second wire electrode pattern 68 are provided in layers (i.e., layers provided closer to a first substrate 6), respectively, that are provided above a layer in which a transparent electrode pattern 49 is provided (see FIG. 18). In a second substrate 4, in this case, the transparent electrode pattern 49 is provided on a glass substrate 41. Wire electrodes (e.g., wire electrodes 49a through 49d) are provided in a striped manner in the transparent electrode pattern 49. On the transparent electrode pattern 49, an insulating film 53 is provided. Provided on the insulating film 53 is the second wire electrode pattern 68 in which wire electrodes (e.g., wire electrodes 68a and 68b), provided in parallel with the transparent electrodes, respectively, are provided in a striped manner. A vertical alignment film 45 is provided so as to cover the first wire electrode pattern 58. A positional relation between respective of the wire electrodes and respective of the transparent electrodes is the same as shown in FIG. 17. Note, however, that insulating layers can be independently provided, instead of the insulating films 53 and 54 (see FIG. 19). For example, insulating layers 153x and 153y can be independently provided on the transparent electrode pattern 49, and insulating layers 154x and 154y can be independently provided. The wire electrode 68a can be provided on the insulating layer 153x, whereas the wire electrode 68b can be provided on the insulting layer 153y. The wire electrode 58a can be provided on the insulating layer 154x, whereas the wire electrode 58b can be provided on the insulating layer 154y.

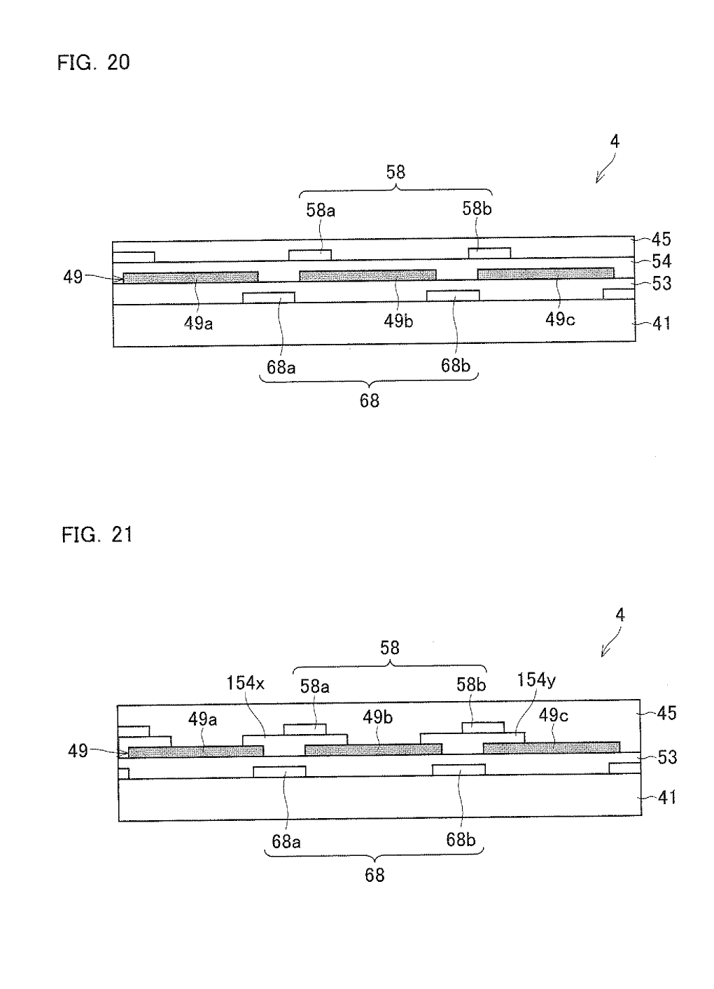

Another viewing angle control panel of the present embodiment can be arranged such that (i) a first wire electrode pattern 58 is provided in a layer (i.e., a layer provided closer to a first substrate 6) provided above a layer in which a transparent electrode pattern 49 is provided and that (ii) a second wire electrode pattern 68 is provided in a layer provided (i.e., a layer provided closer to a backlight) below the layer in which the transparent electrode pattern 49 is provided (see FIG. 20). In the second substrate 4, in this case, the second wire electrode pattern 68 is provided on the glass substrate 41. Wire electrodes (e.g., wire electrodes 68a and 68b) are provided in a striped manner in the second wire electrode pattern 68. On the second wire electrode pattern 68, the insulating film 53 is provided. Provided on the insulating film 53 is the transparent electrode pattern 49 in which transparent electrodes (e.g., transparent electrodes 49a through 49c), positioned in parallel with the wire electrodes, respectively, are provided in a striped manner. On the transparent electrode pattern 49, the insulating film 54 is provided. Provided on the insulating film 54 is a first wire electrode pattern 58 in which wire electrodes (e.g., wire electrodes 58a and 58b) are provided in a striped manner. The vertical alignment film 45 is provided so as to cover the first wire electrode pattern 58. In the arrangement, insulating layers can be also independently provided, instead of the insulating film 54 (see FIG. 21). For example, insulating layers 154x and 154y can be independently provided on the transparent electrode pattern 49. A wire electrode 58a can be provided on the insulating layer 154x, whereas a wire electrode 58b can be provided on the insulating film 154y.

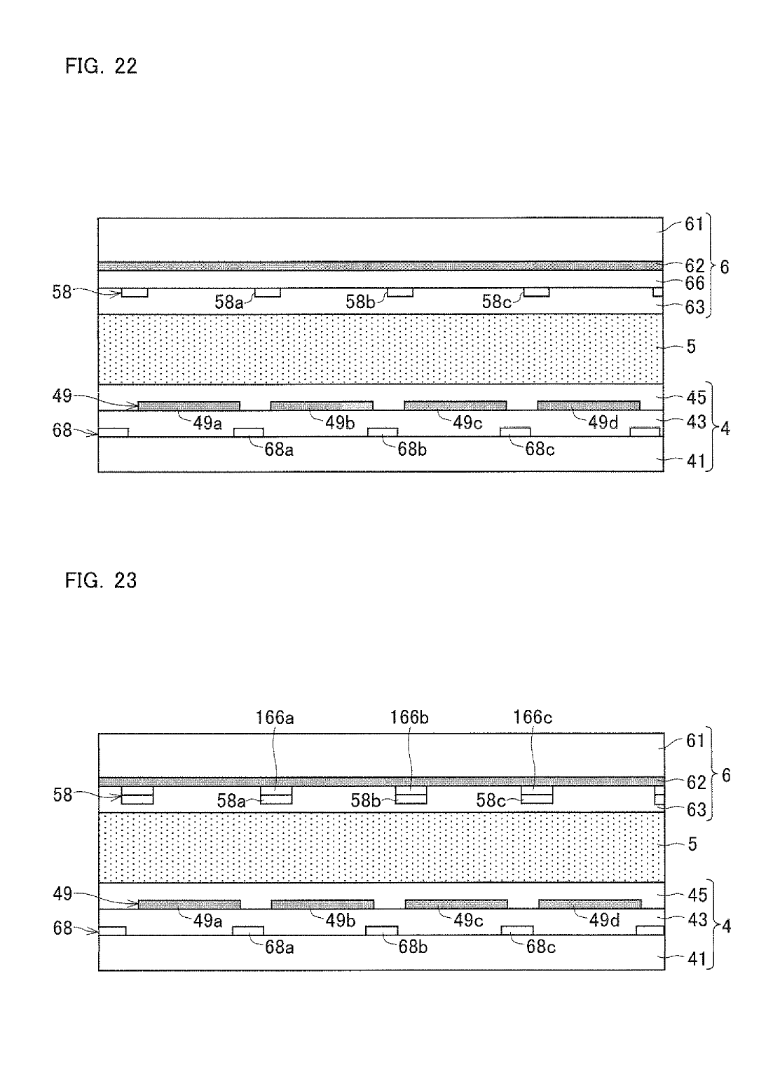

Also, the arrangement shown in FIG. 17 deals the case where the first wire electrode pattern 58 and the second wire electrode pattern 68 are provided in the second substrate 4. However, the present embodiment is not limited to this. Alternatively, yet another viewing angle control panel 2 of the present embodiment can be arranged such that a second wire electrode pattern 68 is provided in a second substrate 4 and that a first wire electrode pattern 58 is provided in a first substrate 6 (see FIG. 22). In the first substrate 6, in this case, a counter electrode pattern 62 is provided on a glass substrate 61. Counter electrode 64 is provided over the glass substrate 61 in the counter electrode pattern 62. On the counter electrode pattern 62, an insulating film 66 is provided. Provided on the insulating film 66 is a first wire electrode pattern 58 in which wire electrodes (e.g., wire electrodes 58a through 58c) are provided in a striped manner. A vertical alignment film 63 is provided so as to cover the first wire electrode pattern 58. In the second substrate 4, on the other hand, a second wire electrode pattern 68 is provided on a glass substrate 41. Wire electrodes (e.g., wire electrodes 68a through 68c) are provided in a striped manner in the second wire electrode pattern 68. On the second wire electrode pattern 68, an insulating film 43 is provided. Provided on the insulating film 43 is a transparent electrode pattern 49 in which transparent electrodes (e.g., transparent electrodes 49a through 49c) are provided in a striped manner. A vertical alignment film 45 is provided so as to cover the transparent electrode pattern 49. A positional relation between respective of the wire electrodes and respective of the transparent electrodes is the same as shown in FIG. 17. Note that insulating layers 166a through 166c can be independently provided on the counter electrode pattern 62, instead of the insulating film 66 in the first substrate 6 (see FIG. 23). The wire electrode 58a can be provided on the insulating layer 166a, whereas the wire electrode 58b and 58c can be provided on the insulating layers 166b and 166c, respectively.

### Fourth Embodiment

Each of the arrangements (e.g., each of the arrangements shown in FIGS. 1 and 17, respectively) deals with the case where a transparent electrode pattern is arranged in a striped manner. However, the present embodiment can be alternatively arranged such that a transparent electrode pattern, in which a transparent electrode is provided over a glass substrate, is provided. In the arrangement, wire electrodes are provided in a layer between a layer in which a counter electrode pattern is provided and a layer in which a transparent electrode pattern is provided.

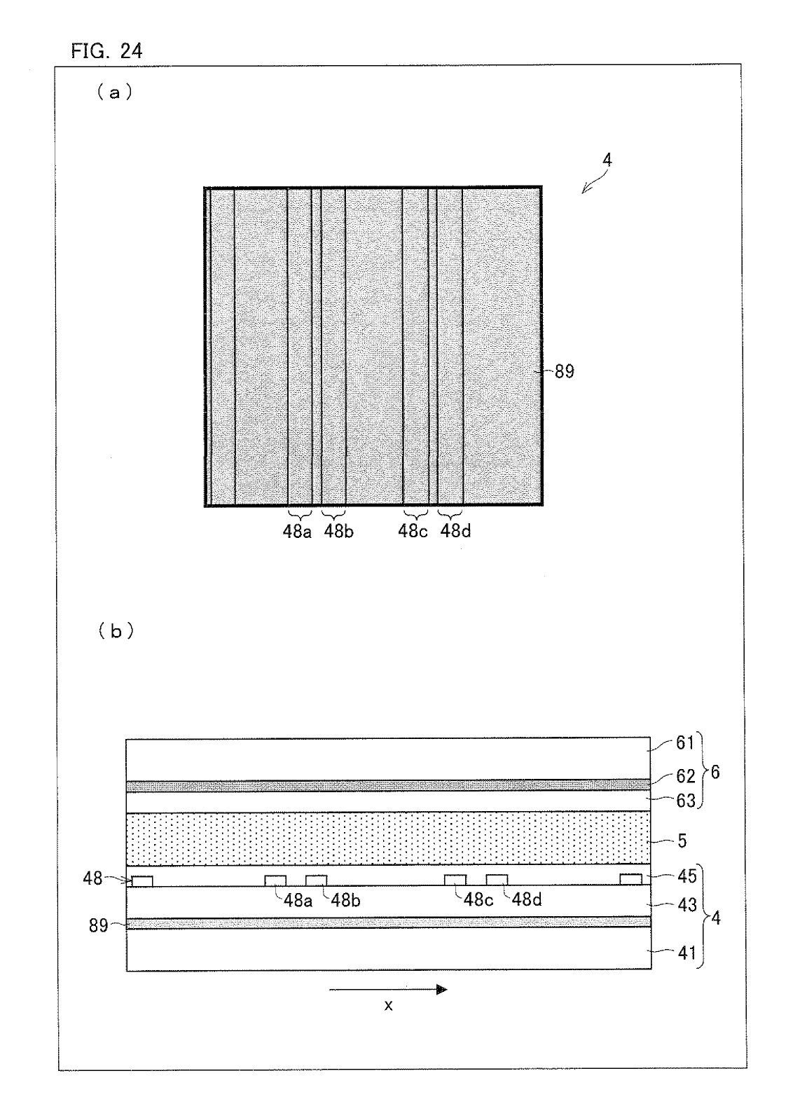

For example, a second substrate 4 includes a glass substrate 41, a wire electrode pattern 48, an insulating film 43, a transparent electrode pattern 89, and a vertical alignment film 45 (see FIGS. 24(a) and 24(b)). On the glass substrate 41, the transparent electrode pattern 89 is provided. A transparent electrode is provided over the glass substrate 41 in the transparent electrode pattern 89. The insulating film 43 is provided so as to cover the transparent electrode pattern 89. Provided on the insulating film 43 is the wire electrode pattern 48 in which wire electrodes (e.g., wire electrodes 48a through 48d) are provided in a striped manner. The vertical alignment film 45 is provided so as to cover the wire electrode pattern 48. The transparent electrode (the transparent electrode pattern 89) is made of a material, having a light transmitting property, such as ITO. The wire electrodes (the wire electrode pattern 48) can be made of a material having a light transmitting property or a material having no light transmitting property.

In the wire electrode pattern 48, plural pairs of two wire electrodes are provided at intervals in a width direction (a direction x shown in FIG. 24(b)) orthogonal to a direction in which the wire electrodes extend and orthogonal to a normal direction of a substrate surface (see FIGS. 24(a) and 24(b)). The two wire electrodes of each of the plural pairs are parallel and close to each other in the direction x. Specifically, the wire electrodes 48a and 48b, which extend so as to be parallel and close to each other in the direction x, constitute a pair. Also, wire electrodes 48c and 48d, which extend so as to be parallel and close to each other in the direction x, constitute a pair. A first substrate 6, on the other hand, includes a glass substrate 61, a counter electrode pattern 62, and a vertical alignment film 63 (see FIG. 24(b)). On the glass substrate 61, the counter electrode pattern 62 is provided. A counter electrode 64 is provided over the glass substrate 61 in the counter electrode pattern 62. The vertical alignment film 63 is provided so as to cover the counter electrode pattern 62. The counter electrode pattern 62 is made of a material, having a light transmitting property, such as ITO.

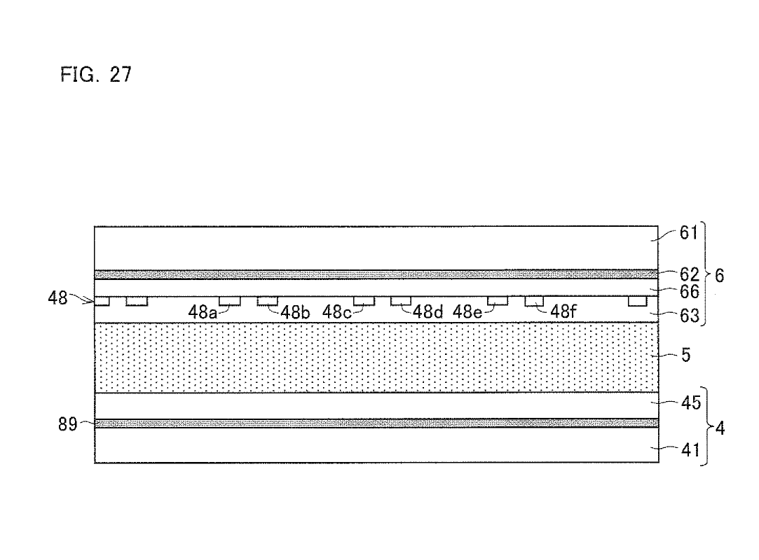

The arrangement shown in FIGS. 24(a) and 24(b) deals with the case where the wire electrode pattern 48 is provided in the second substrate 4. Alternatively, the present embodiment can be arranged such that a wire electrode pattern 48 is provided in a first substrate 6 (see FIG. 27).

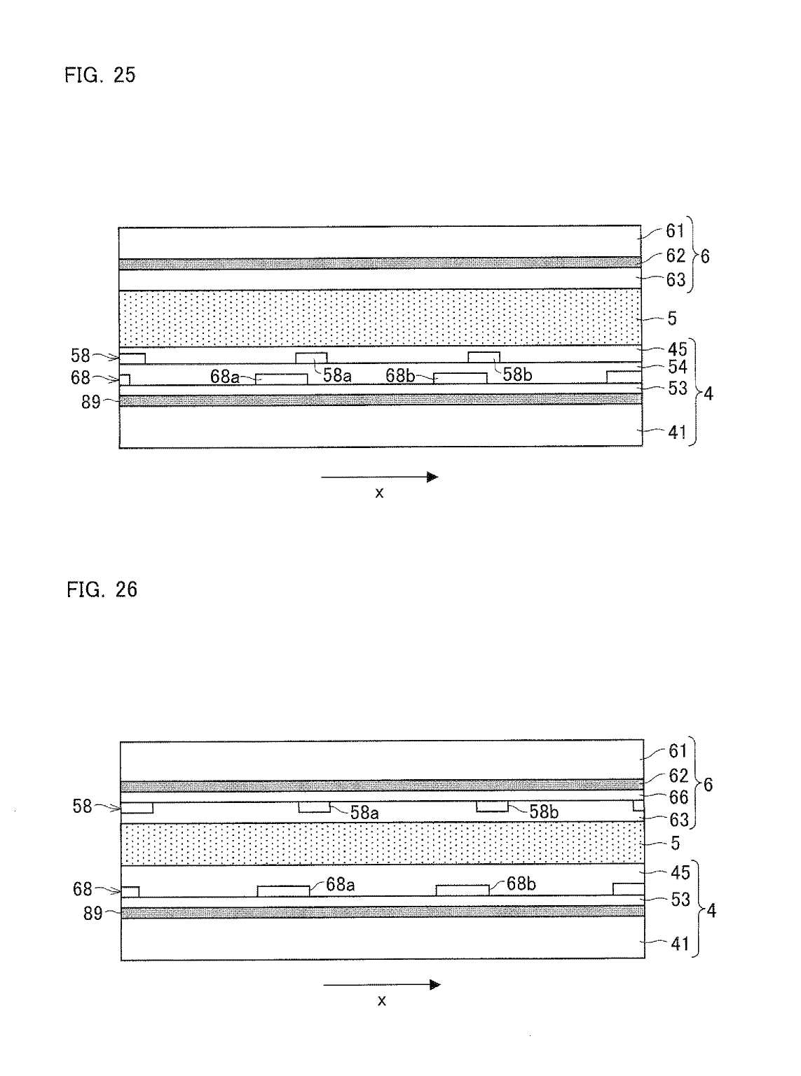

The arrangement shown in FIG. 24(b) deals with the case where the wire electrodes 48a and 48b, which constitute a pair, are provided in a single layer. Alternatively, the present embodiment can be arranged such that wire electrodes 48a and 48b are provided in different layers (i.e., the wire electrodes 48a and 48b are provided so as to belong to different electrode patterns), respectively. For example, the present embodiment can be arranged in the manner shown in FIG. 25. Specifically, on a glass substrate 41, a transparent electrode pattern 89 is provided. A transparent electrode is provided over the glass substrate 41 in the transparent electrode pattern 89. An insulting film 53 is provided so as to cover the transparent electrode pattern 89. Provided on the insulting film 53 is a second wire electrode pattern 68 in which second wire electrodes (e.g., second wire electrodes 68a and 68b) are provided in a striped manner. An insulating film 54 is provided so as to cover the second wire electrode pattern 68. Provided on the insulating film 54 is a first wire electrode pattern 58 in which first wire electrodes (e.g., first wire electrodes 58a and 58b) are provided in a striped manner. A vertical alignment film 45 can be provided so as to cover the first wire electrode pattern 58. In a second substrate 4, the wire electrode 58a in the first wire electrode pattern 58 and the wire electrode 68a in the second wire electrode pattern 68, for example, constitute a pair. The wire electrode 58a and the wire electrode 68a (i) extend in parallel with each other and (ii) partially overlap each other in a width direction (a direction x) which is orthogonal to a direction in which the wire electrodes 58a and 68a extend and orthogonal to a normal direction of a substrate surface. Also, the wire electrode 58b in the first wire electrode pattern 58 and the wire electrode 68b in the second wire electrode pattern 68 constitute a pair. The wire electrode 58b and the wire electrode 68b (i) extend in parallel with each other and (ii) partially overlap each other in the width direction (the direction x) which is orthogonal to a direction in which the wire electrodes 58b and 68b extend and orthogonal to the normal direction of the substrate surface and. A plurality of such pairs of respective two wire electrodes are provided at intervals in the direction x.

The arrangement shown in FIG. 25 deals with the case where the first wire electrode pattern 58 and the second wire electrode pattern 68 are provided in the second substrate 4. Alternatively, the present embodiment can be arranged such that a first wire electrode pattern 58 is provided in a first substrate 6 and that a second wire electrode pattern 68 is provided in a second substrate 4 (see FIG. 26). In the arrangement, likewise, a wire electrode 58a in the first wire electrode pattern 58 and a wire electrode 68a in the second wire electrode 68 constitute a pair. The wire electrode 58a and the wire electrode 68a (i) extend in parallel with each other and (ii) partially overlap each other in a width direction (in a direction x) orthogonal to a direction in which the wire electrodes 58a and 68a extend and orthogonal to a normal direction of a surface substrate. Also, a wire electrode 58b in the first wire electrode pattern 58 and a wire electrode 68b in the second wire electrode pattern 68 constitute a pair. The wire electrode 58b and the wire electrode 68b (i) extend in parallel with each other and (ii) partially overlap each other in the width direction (in the direction x) orthogonal to a direction in which the wire electrodes 58b and 68b extend and orthogonal to the normal direction of the substrate surface. A plurality of such pairs of respective two wire electrodes are provided at intervals in the direction x.

The arrangements shown in FIGS. 25 and 26 deals with the case where two wire electrodes (e.g., the wire electrodes 58a and 68a), constituting a pair, partially overlap each other. However, the present embodiment is not limited to this. Alternatively, the present embodiment can be arranged such that two wire electrodes are provided close to each other in a direction x instead of overlapping each other.

### Fifth Embodiment

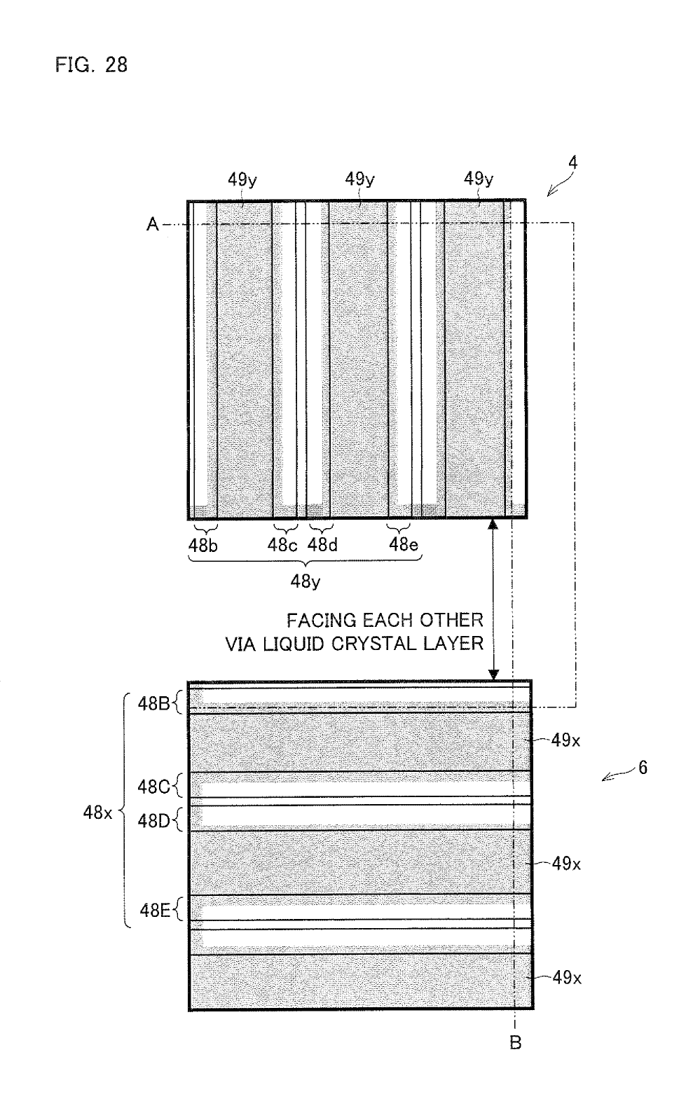

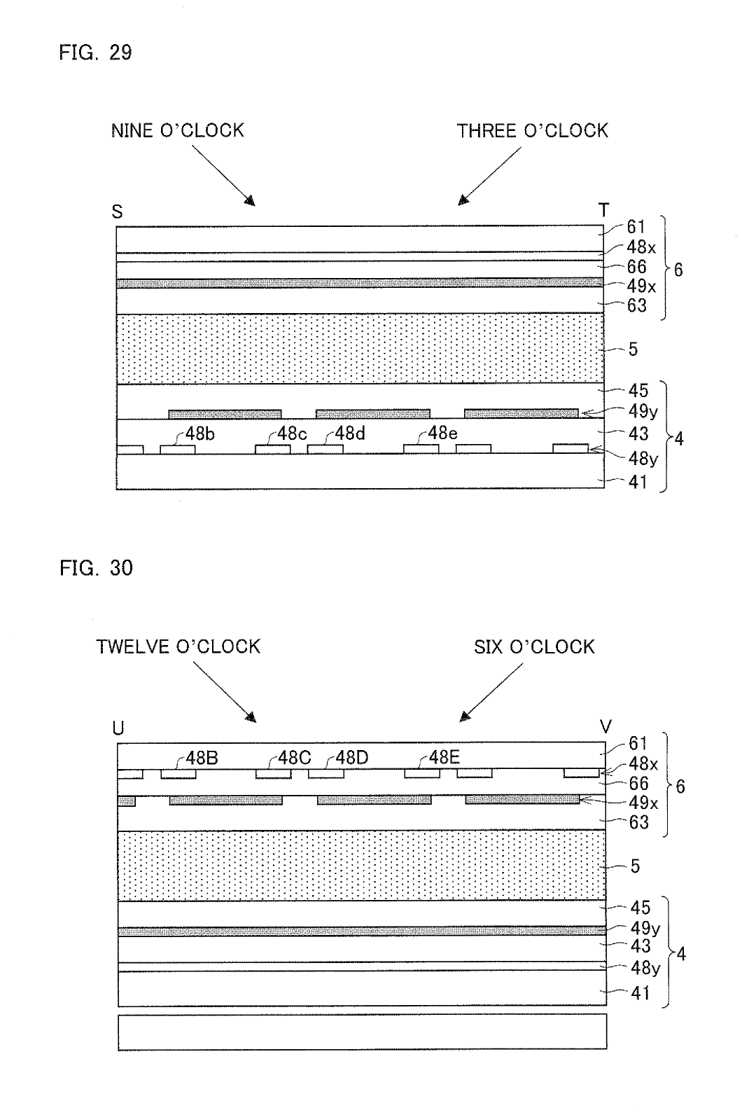

A viewing angle control panel of the present embodiment can be alternatively arranged such that (i) a transparent electrode pattern and a wire electrode pattern are provided in a first substrate 6 and in a second substrate 4, respectively and (ii) the first substrate 6 and the second substrate 4 are provided so that their transparent electrode patterns 49 are orthogonal to each other (see FIG. 28). FIG. 29 is a cross sectional view taken on a dash line A of FIG. 28. FIG. 30 is a cross sectional view taken on a dash line B of FIG. 28.

For example, the viewing angle control panel 2 of the present embodiment can have arrangements as shown in FIGS. 28 through 30. That is, in a second substrate 4, a wire electrode pattern 48y is provided on a glass substrate 41. Wire electrodes (e.g., wire electrodes 48b through 48e) are provided in a striped manner in the wire electrode pattern 48y. An insulting film 43 is provided so as to cover the wire electrode pattern 48y. Provided on the insulating film 43 is a transparent electrode pattern 49y in which transparent electrodes provided in parallel with the wire electrodes, respectively, are provided in a striped manner. A vertical alignment film 45 is provided so as to cover the transparent electrode pattern 49y. Two wire electrodes (e.g., wire electrodes 48c and 48d) in the wire electrode pattern 48y are provided so as to correspond to respective of spaces between the transparent electrodes in the transparent electrode pattern 49y. The two wire electrodes 48c and 48d extend in parallel with the transparent electrodes so that the two wire electrodes 48c and 48d and the respective of the spaces overlap each other. In a first substrate 6, on the other hand, a wire electrode pattern 48x is provided on a glass substrate 61. Wire electrodes (e.g., wire electrodes 48B through 48E) are provided in a striped manner in the wire electrode pattern 48x. An insulating film 66 is provided so as to cover the wire electrode pattern 48x. Provided on the insulating film 66 is a transparent electrode pattern 49x in which transparent electrodes provided in parallel with the wire electrodes, respectively, are provided in a striped manner. A vertical alignment film 63 is provided so as to cover the transparent electrode pattern 49x. Two wire electrodes in the wire electrode pattern 48x (e.g., wire electrodes 48C and 48D) are provided so as to correspond to respective of spaces between the transparent electrodes in the transparent electrode pattern 49x. The two wire electrodes 48C and 48D extend in parallel with the transparent electrodes so that the two wire electrodes 48C and 48D and the respective of the spaces overlap each other. In the present embodiment, (i) the first substrate 6 and the second substrate 4 are provided so that the transparent electrode pattern 49x (or the wire electrode pattern 48x) in the first substrate 6 and the transparent electrode pattern 49y (or the wire electrode pattern 48y) in the second substrate 4 are orthogonal to each other, and (ii) the liquid crystal layer 5 is sandwiched between the first substrate 6 and the second substrate 4 (see FIG. 28).

In the arrangements of the present embodiment, (i) prescribed electric potentials are applied to the transparent electrode patterns 49x (which is provided in the first substrate 6) and 49y (which is provided in the second substrate 4), respectively, and (ii) electric potentials of the wire electrodes 48b through 48e (which are provided in the second substrate 4) and electric potentials of the wire electrodes 48B through 48E (which are provided in the first substrate 6) are controlled (see FIGS. 28 through 30). This causes a viewing angle characteristic of a liquid crystal display device 1 (see FIGS. 3 and 28) to be switched. S, T, U, and V shown in FIGS. 29 and 30 correspond to those shown in FIG. 9, respectively.

It is supposed that electric potentials of the transparent electrode pattern 49x, the transparent electrode pattern 49y, the wire electrodes 48b through 48e, and the wire electrodes 48B through 48E are V49x, V49y, V48b through V48e, and V48B through V48E, respectively. The following description deals with a case in which (i) control is carried out so that V49y, V48b, V48c, V48d, and V48e are all greater than V49x or are all smaller than V49x and (ii) control is carried out so that V49x, V48B, V48C, V48D, and V48E are all greater than V49y or are all smaller than V49y.

First, the following description deals with a case in which control is carried out so that

|V49x−V49y|>|V49x−V48b|

|V49x−V49y|<|V49x−V48c|

|V49x−V49y|>|V49x−V48d|

|V49x−V49y|<|V49x−V48e|

|V49y−V49x|=|V49x−V48B|

|V49y−V49x|=|V49x−V48C|

|V49y−V49x|=|V49x−V48D|

|V49y−V49x|=|V49x−V48E|

are satisfied. In this case, the liquid crystal display device 1 has a narrow viewing angle characteristic, in which the liquid crystal display device 1 is visible solely in a three o'clock direction and in a front surface direction shown in FIGS. 8, 9, 29, and 30.

Also, the following description deals with a case in which control is carried out so that

|V49x−V49y|<|V49x−V48b|

|V49x−V49y|>|V49x−V48c|

|V49x−V49y|<|V49x−V48d|

|V49x−V49y|>|V49x−V48e|

|V49y−V49x|=|V49x−V48B|

|V49y−V49x|=|V49x−V48C|

|V49y−V49x|=|V49x−V48D|

|V49y−V49x|=|V49x−V48E|

are satisfied. In this case, the liquid crystal display device 1 has a narrow viewing angle characteristic, in which the liquid crystal display device 1 is visible solely in a nine o'clock direction and in the front surface direction shown in FIGS. 8, 9, 29, and 30.

Also, the following description deals with a case in which control is carried out so that

|V49y−V49x|<|V49y−V48B|

|V49y−V49x|>|V49y−V48C|

|V49y−V49x|<|V49y−V48D|

|V49y−V49x|>|V49y−V48E|

|V49x−V49y|=|V49y−V48b|

|V49x−V49y|=|V49y−V48c|

|V49x−V49y|=|V49y−V48d|

|V49x−V49y|=|V49y−V48e|

are satisfied. In this case, the liquid crystal display device 1 has a narrow viewing angle characteristic, in which the liquid crystal display device 1 is visible solely in the six o'clock direction and in the front surface direction shown in FIGS. 8, 9, 29, and 30.

Also, the following description deals with a case in which control is carried out so that

|V49y−V49x|>|V49y−V48B|

|V49y−V49x|<|V49y−V48C|

|V49y−V49x|>|V49y−V48D|

|V49y−V49x|<|V49y−V48E|

|V49x−V49y|=|V49y−V48b|

|V49x−V49y|=|V49y−V48c|

|V49x−V49y|=|V49y−V48d|

|V49x−V49y|=|V49y−V48e|

are satisfied. In this case, the liquid crystal display device 1 has a narrow viewing angle characteristic, in which the liquid crystal display device 1 is visible solely in a twelve o'clock direction and in the front surface direction shown in FIGS. 8, 9, 29, and 30.

Also, the following description deals with a case in which control is carried out so that:

|V49x−V49y|>>|V49x−V48b|

|V49x−V49y|<<|V49x−V48c|

|V49x−V49y|<<|V49x−V48d|

|V49x−V49y|>>|V49x−V48e|

|V49y−V49x|=|V49x−V48B|

|V49y−V49x|=|V49x−V48C|

|V49y−V49x|=|V49x−V48D|

|V49y−V49x|=|V49x−V48E|; (i)

|V49y−V49x|>>|V49y−V48B|

|V49y−V49x|<<|V49y−V48C|

|V49y−V49x|<<|V49y−V48D|

|V49y−V49x|>>|V49y−V48E|

|V49x−V49y|=|V49y−V48b|

|V49x−V49y|=|V49y−V48c|

|V49x−V49y|=|V49y−V48d|

|V49x−V49y|=|V49y−V48e|; or (ii)

|V49x−V49y|>>|V49x−V48b|

|V49x−V49y|<<|V49x−V48c|

|V49x−V49y|<<|V49x−V48d|

|V49x−V49y|>>|V49x−V48e|

|V49y−V49x|>>|V49x−V48B|

|V49y−V49x|<<|V49x−V48C|

|V49y−V49x|<<|V49x−V48D|

|V49y−V49x|>>|V49x−V48E|

are satisfied. In this case, it is possible to cause the liquid crystal display device 1 to have a wide viewing angle characteristic (i.e., the liquid crystal display device 1 is visible in all directions).

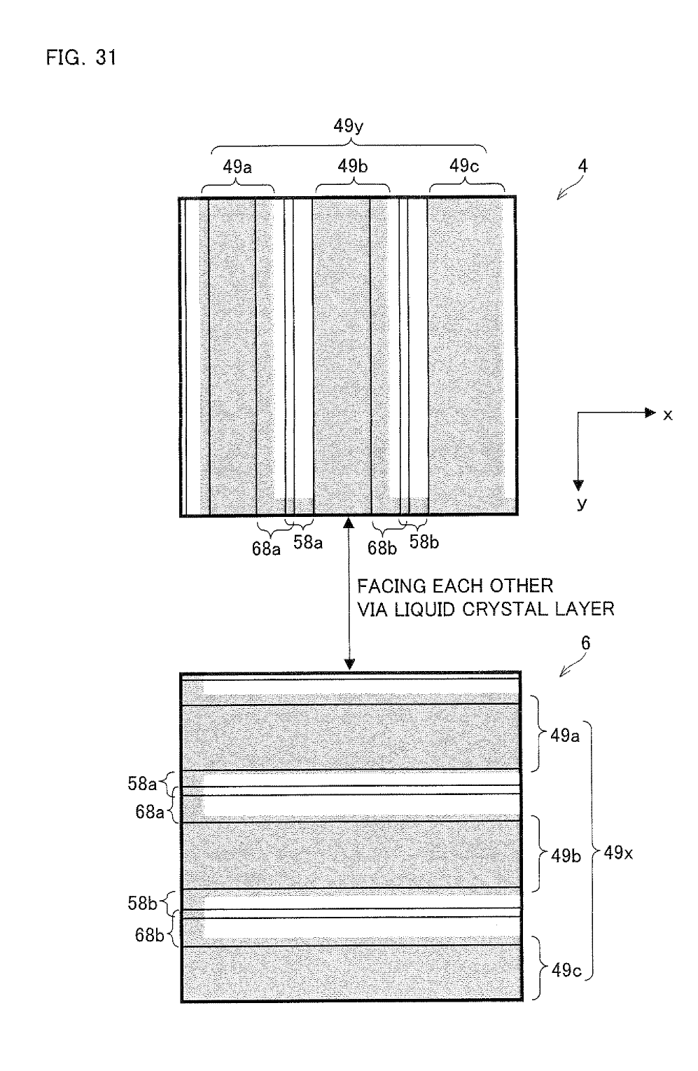

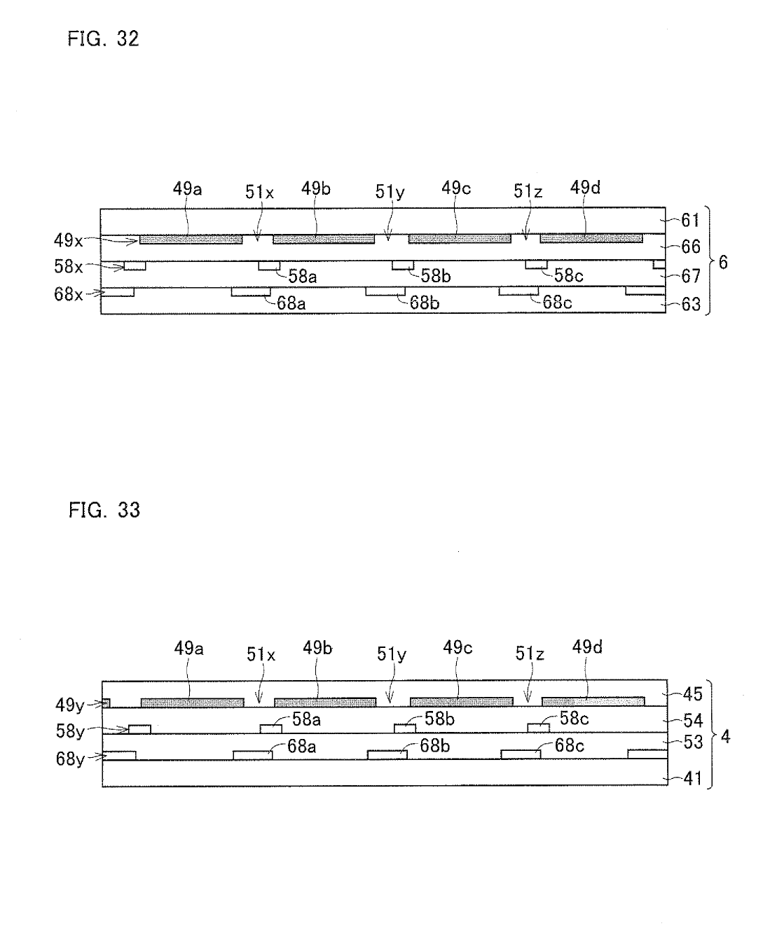

As to how the substrates (the first substrate 6 and the second substrate 4) are arranged, the present embodiment is not limited to those shown in FIGS. 28 through 30, respectively. For example, substrates can have an arrangement in which two wire electrode patterns (first and second wire electrode patterns) are provided in each substrate (in each of the first substrate 6 and the second substrate 4). Such an arrangement is shown in FIGS. 31 through 33. FIG. 32 is a cross sectional view obtained when the first substrate 6 shown in FIG. 31 is cut along a line extending in a direction y. FIG. 33 is a cross sectional view obtained when the second substrate 4 shown in FIG. 31 is cut along a line extending in a direction x. As shown in FIGS. 31 through 33, the first substrate 6 includes a transparent electrode pattern 49x, a first wire electrode pattern 58x, and a second wire electrode pattern 68x. One wire electrode (e.g., the wire electrode 58a) in the first wire electrode pattern 58x and one wire electrode (e.g., the wire electrode 68a) in the second wire electrode pattern 68x are provided so as to correspond to respective of spaces (e.g., a space 51x) between adjacent transparent electrodes in the transparent electrode pattern 49x. The two wire electrodes (e.g., the wire electrodes 58a and 68a) extend in parallel with two transparent electrodes (e.g., transparent electrodes 49a and 49b), respectively, such that the two wire electrodes (e.g., the wire electrodes 58a and 68a) and the respective of the spaces (e.g., the space 51x) overlap each other. The second substrate 4, on the other hand, includes a transparent electrode pattern 49y, a first wire electrode pattern 58y, and a second wire electrode pattern 68y. One wire electrode (e.g., a wire electrode 58b) in the first wire electrode pattern 58y and one wire electrode (e.g., a wire electrode 68b) in the second wire electrode pattern 68y are provided so as to correspond to respective of spaces (e.g., a space 51y) between transparent electrodes in the transparent electrode pattern 49y. Two wire electrodes (e.g., the wire electrodes 58b and 68b) extend in parallel with the transparent electrodes (e.g., transparent electrodes 49b and 49c), respectively, such that the two wire electrodes (e.g., the wire electrodes 58b and 68b) and the respective of the spaces (e.g., the space 51y) overlap each other. In the present embodiment, (i) the substrates (the first substrate 6 and the second substrate 4) are provided such that the transparent electrode pattern 49x in the first substrate 6 and the transparent electrode pattern 49y in the second substrate 4 are orthogonal to each other, and (ii) a liquid crystal layer is sandwiched between the first substrates 6 and the second substrate 4.

### Sixth Embodiment

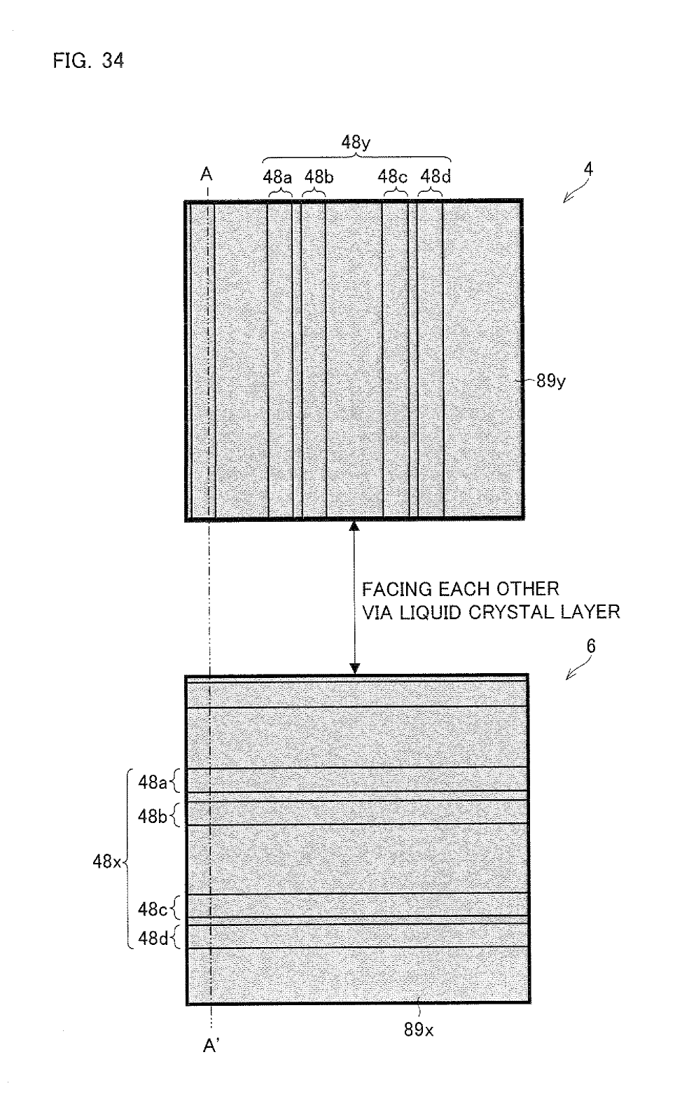

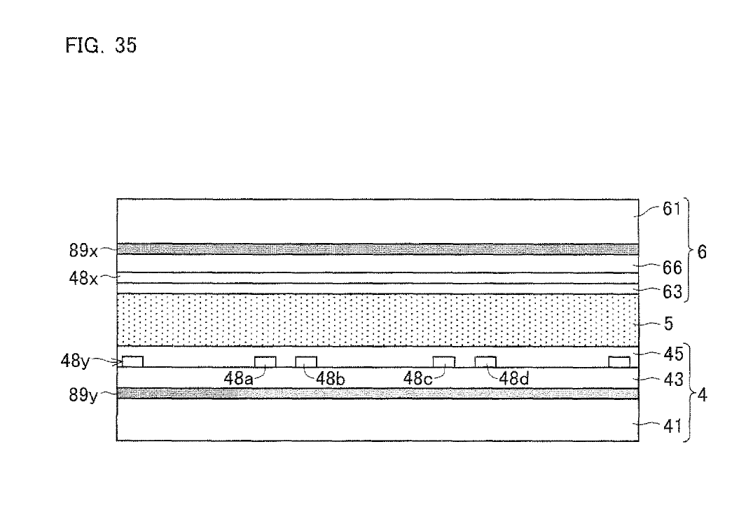

In the present embodiment, each substrate (a first substrate 6 and a second substrate 4) can be alternatively arranged as shown in FIGS. 34 and 35 (FIG. 35 is a cross sectional view taken on a line A of FIG. 34). Specifically, the first substrate 6 includes (i) a transparent electrode pattern 89x in which transparent electrode is provided over a substrate 61 and (ii) a wire electrode pattern 48x provided in a layer that is provided between layers in which the transparent electrode pattern 89x and a liquid crystal layer 5 are provided, respectively. The second substrate 4 includes (i) a transparent electrode pattern 89y in which transparent electrode is provided over a substrate 41 and (ii) a wire electrode pattern 48y provided in a layer that is provided between layers in which the transparent electrode pattern 89y and the liquid crystal layer 5 are provided, respectively. In the wire electrode pattern 48x in the first substrate 6, plural pairs of two wire electrodes are provided at intervals in a width direction orthogonal to a direction in which the two electrodes extend and orthogonal to a normal direction of a substrate surface, two wire electrodes of each of the plural pairs provided in parallel with and close to each other in the width direction. For example, a wire electrode 48a and a wire electrode 48b, which extend so as to be parallel and close to each other in the width direction, constitute pair. In the wire electrode pattern 48y in the second substrate 4, plural pairs of two wire electrodes are provided at intervals in a width direction orthogonal to a direction in which the two wire electrodes extend and orthogonal to a normal direction of a substrate surface, two wire electrodes of each of the plural pairs provided in parallel with and close to each other in the width direction. For example, wire electrodes 48a and 48b, which extend so as to be parallel and close to each other in the width direction, constitute a pair. In the present embodiment, (i) the first substrates 6 and the second substrates 4 are provided so that the wire electrode pattern 48x in the first substrate 6 and the wire electrode pattern 48y in the second substrate 4 are orthogonal to each other, and (ii) the liquid crystal layer 5 is sandwiched between the first substrate 6 and the second substrate 4 (see FIG. 34).

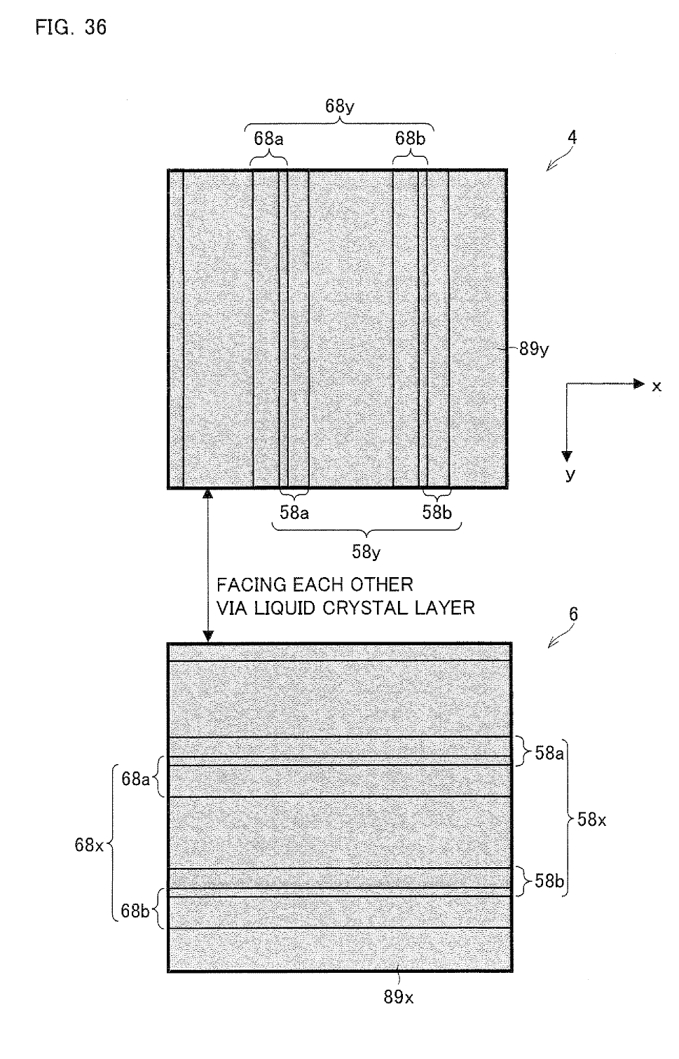

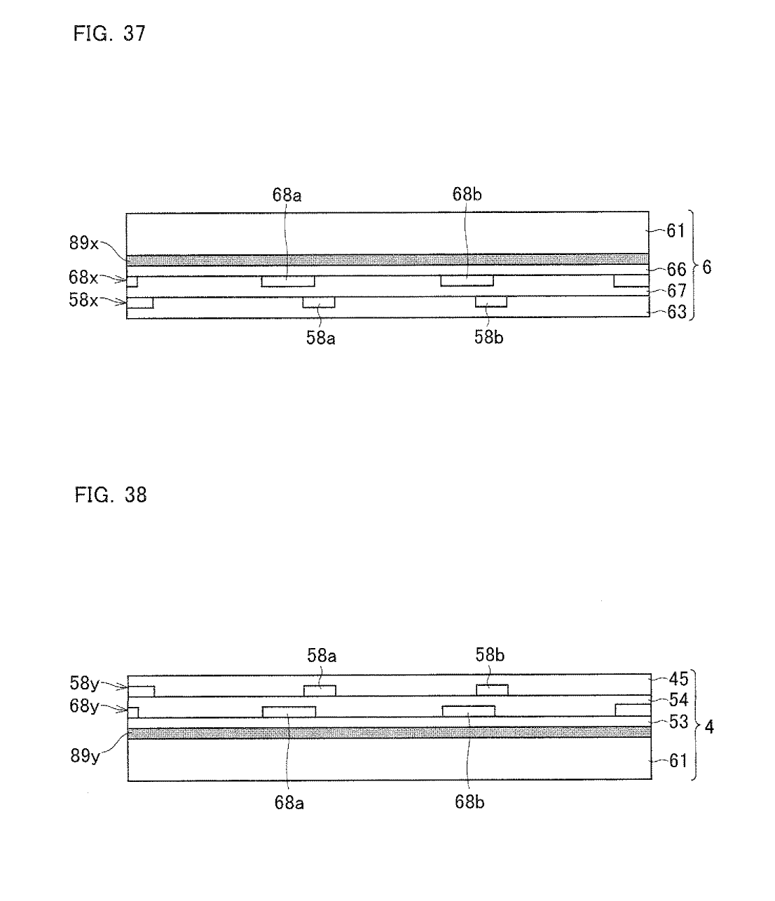

In this case, substrates can have an arrangement in which two wire electrode patterns (first and second wire electrode patterns) are provided in each substrate (in each of the first substrate 6 and the second substrates 4). Such an arrangement is shown in FIGS. 36 through 38. FIG. 37 is a cross sectional view obtained when the first substrate 6 shown in FIG. 36 is cut along a line extending in a direction y. FIG. 38 is a cross sectional view obtained when the second substrate 4 shown in FIG. 36 is cut along a line extending in a direction x. As shown in FIGS. 37 and 38, the first substrate 6 includes (i) a transparent electrode pattern 68x in which a transparent electrode is provided over a glass substrate 61, (ii) a first wire electrode pattern 58x, and (iii) a second wire electrode pattern 68x, whereas the second substrate 4 includes (i) a transparent electrode pattern 89y in which a transparent electrode is provided over a glass substrate 61, (ii) a first wire electrode pattern 58y, and (iii) a second wire electrode pattern. In the first substrate 6, a wire electrode 58a in the first wire electrode pattern 58x and a wire electrode 68a in the second wire electrode pattern 68x, for example, constitute a pair. The wire electrode 58a and the wire electrode 68a (i) extend in parallel with and (ii) partially overlap each other in a width direction orthogonal to a direction in which they extend and orthogonal to a normal direction of a substrate surface (see FIGS. 36 and 37). In the second substrate 4, on the other hand, a wire electrode 58a in the first wire electrode pattern 58y and a wire electrode 68a in the second wire electrode 68y, for example, constitute a pair. The wire electrodes 58a and 68a (i) extend in parallel with each other and (ii) partially overlap each other in a direction orthogonal to a direction in which they extend and orthogonal to a normal direction of a substrate surface. In the arrangement, (i) the first substrate 6 and the second substrate 4 are provided so that the first wire electrode pattern 58x (or the second wire electrode pattern 68x) in the first substrate 6 and the first wire electrode pattern 58y (or the second wire electrode pattern 68y) in the second substrate 4 are orthogonal to each other, and (ii) the liquid crystal layer 5 is sandwiched between the first substrate 6 and the second substrate 4 (see FIG. 36).

The arrangement shown in FIGS. 36 through 38 deals with the case where the two wire electrodes (e.g., the wire electrodes 58a and 68a), constituting a pair, partially overlap each other. However, the present embodiment is not limited to this. Alternatively, the present embodiment can be arranged such that two wire electrodes are provided close to each other in a width direction instead of overlapping each other.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

A liquid crystal display device of the present invention is suitable for a liquid crystal display device in which privacy should be protected and a security should be improved.

1. A viewing angle control panel comprising two substrates facing each other and a liquid crystal layer provided between the substrates, a combination of said viewing angle control panel and a display panel constituting a liquid crystal display device in which a viewing angle characteristic can be switched, wherein:
(i) one of the two substrates includes a counter electrode pattern in which a counter electrode is provided over said one of the two substrates and (ii) the other one of the two substrates includes a transparent electrode pattern in which transparent electrodes are provided in a striped manner; and
two wire electrodes are provided in parallel with transparent electrodes so as to correspond to respective of spaces in the transparent electrode pattern and such that the two wire electrodes and the respective of the spaces overlap each other, respectively.

2. The viewing angle control panel as set forth in claim 1, wherein:
said two wire electrodes are a first wire electrode and a second wire electrode; and
the first wire electrode and one side end part of the respective of the spaces overlap each other, and the second wire electrode and the other side end part of the respective of the spaces overlap each other.

3. The viewing angle control panel as set forth in claim 1, wherein:
two transparent electrodes between which the respective of the spaces is sandwiched are a first transparent electrode and a second transparent electrode, and said two wire electrodes are a first wire electrode and a second wire electrode; and
the first and second wire electrodes are provided in a single layer.

4. The viewing angle control panel as set forth in claim 3, wherein (i) the first and second wire electrodes and (ii) the transparent electrode pattern are provided in different layers, respectively.

5. The viewing angle control panel as set forth in claim 4, wherein the first wire electrode and one side end part of the first transparent electrode overlap each other, and the second wire electrode and one side end part of the second transparent electrode overlap each other.

6. The viewing angle control panel as set forth in claim 4, wherein the substrate, including the transparent electrode pattern, includes the first and second wire electrodes.

7. The viewing angle control panel as set forth in claim 4, wherein the substrate, including the counter electrode pattern, includes the first and second wire electrodes.

8. The viewing angle control panel as set forth in claim 3, wherein (i) the first and second wire electrodes and (ii) the transparent electrode pattern are provided in a single layer.

9. The viewing angle control panel as set forth in claim 8, wherein the first wire electrode is provided close to the first transparent electrode, and the second wire electrode is provided close to the second transparent electrode.

10. The viewing angle control panel as set forth in claim 1, wherein:
two transparent electrodes between which the respective of the spaces is sandwiched are a first transparent electrode and a second transparent electrode; and
said two wire electrodes are a first wire electrode and a second wire electrode; and
the first and second wire electrodes are provided in different layers, respectively.

11. The viewing angle control panel as set forth in claim 10, wherein the first wire electrode and one side end part of the first transparent electrode overlap each other, and the second wire electrode and one side end part of the second transparent electrode overlap each other.

12. The viewing angle control panel as set forth in claim 11, wherein the first and second wire electrodes overlap each other.

13. The viewing angle control panel as set forth in claim 10, wherein the substrate, including the counter electrode pattern, includes the first and second wire electrodes.

14. The viewing angle control panel as set forth in claim 10, wherein the substrate, including the counter electrode pattern, includes the first wire electrode, and the substrate, including the transparent electrode pattern, includes the second wire electrode.

15. The viewing angle control panel as set forth in claim 10, wherein the substrate, including the transparent electrode pattern, includes the first and second wire electrodes.

16. The viewing angle control panel as set forth in claim 15, wherein the first and second wire electrodes are provided in a layer provided below a layer in which the transparent electrode pattern is provided.

17. The viewing angle control panel as set forth in claim 15, wherein the first and second wire electrodes are provided in a layer provided above a layer in which the transparent electrode pattern is provided.

18. The viewing angle control pattern as set forth in claim 15, wherein the transparent electrode pattern is provided between a layer in which the first wire electrode is provided and a layer in which the second wire electrode is provided.

19. A viewing angle control panel comprising two substrates facing each other and a liquid crystal layer provided between the substrates, a combination of said viewing angle control panel and a display panel constituting a liquid crystal display device in which a viewing angle characteristic can be switched, wherein:
(i) one of the two substrates includes a counter electrode pattern in which a counter electrode is provided over said one of the two substrates, and (ii) the other one of the two substrates includes a transparent electrode pattern in which a transparent electrodes is provided over the other one of the two substrates; and
plural pairs of two wire electrodes are provided, between the counter electrode pattern and the transparent electrode pattern, at intervals in a width direction orthogonal to a direction in which the wire electrodes extend and orthogonal to a normal direction of a substrate surface, said two wire electrodes of each of the plural pairs being provided in parallel with each other, and being close to or overlapping each other in the width direction.

20. The viewing angle control panel as set forth in claim 19, wherein the two wire electrodes of each of the plural pairs are provided in a single layer.

21. The viewing angle control panel as set forth in claim 19, wherein the two wire electrodes of each of the plural pairs are provided in different layers, respectively.

22. The viewing angle control panel as set forth in claim 21, wherein the two wire electrodes include a part where they overlap each other and a part where they do not overlap each other.

23. The viewing angle control panel as set forth in claim 19, wherein the substrate, including the counter electrode pattern, includes the plural pairs of two wire electrodes.

24. The viewing angle control panel as set forth in claim 19, wherein (i) the substrate, including the counter electrode pattern, includes ones of the plural pairs of two wire electrodes, and (ii) the substrate, including the transparent electrode pattern, includes the other ones of the plural pairs of two wire electrodes.

25. The viewing angle control panel as set forth in claim 19, wherein the substrate, including the transparent electrode pattern, includes the plural pairs of two wire electrodes.

26. The viewing angle control panel as set forth in claim 1, wherein setting of electric potentials, being applied to the two wire electrodes in each of the plural pairs, is changed so that a direction in which visibility of the liquid crystal display device is limited is changed.

27. A viewing angle control panel comprising two substrates facing each other and a liquid crystal layer provided between the substrates, a combination of said viewing angle control panel and a display panel constituting a liquid crystal display device in which a viewing angle characteristic can be switched, wherein:
one of the two substrates includes (i) a transparent electrode pattern in which transparent electrodes are provided in a striped manner and (ii) two wire electrodes that are provided in parallel with transparent electrodes so as to correspond to respective of spaces in the transparent electrode pattern and such that the two wire electrodes and the respective of the spaces overlap each other, respectively;
the other one of the two substrates includes (i) a transparent electrode pattern in which transparent electrodes are provided in a striped manner and (ii) two wire electrodes that are provided in parallel with transparent electrodes so as to correspond to respective of spaces in the transparent electrode pattern and such that the two wire electrodes and the respective of the spaces overlap each other, respectively; and
the two substrates are provided so that their transparent electrodes are orthogonal to each other.

28. The viewing angle control panel as set forth in claim 27, wherein: in each of the two substrates,
(i) said two wire electrodes are a first wire electrode and a second wire electrode; and
(ii) the first wire electrode and one side end part of the respective of the spaces overlap each other, and the second wire electrode and the other side end part of the respective of the spaces overlap each other.

29. The viewing angle control panel as set forth in claim 27, wherein, in each of the two substrates, said two wire electrodes are provided in a single layer.

30. The viewing angle control panel as set forth in claim 27, wherein, in each of the two substrates, said two wire electrodes are provided in different layers, respectively.

31. The viewing angle control panel as set forth in claim 30, wherein the first and second wire electrodes overlap each other.

32. A viewing angle control panel comprising two substrates facing each other and a liquid crystal layer provided between the substrates, a combination of said viewing angle control panel and a display panel constituting a liquid crystal display device in which a viewing angle characteristic can be switched, wherein:
one of the two substrates includes (i) a transparent electrode pattern in which a transparent electrode is provided over said one of the two substrates and (ii) plural pairs of two wire electrodes that are provided, between the transparent electrode pattern and the liquid crystal layer, at intervals in a width direction orthogonal to a direction in which the wire electrodes extend and orthogonal to a normal direction of a substrate surface, two wire electrodes of each of the plural pairs being provided in parallel with each other and being close to or overlapping each other in the width direction;
the other one of the two substrates includes (i) a transparent electrode pattern in which a transparent electrode is provided over the other one of the two substrates and (ii) plural pairs of two wire electrodes that are provided, between the transparent electrode pattern and the liquid crystal layer, at intervals in a width direction orthogonal to a direction in which the wire electrodes extend and orthogonal to a normal direction of a substrate surface, said two wire electrodes of each of the plural pairs being provided in parallel with each other, and being close to or overlapping each other in the width direction; and
the two substrates are provided so that their wire electrodes are orthogonal to each other.

33. The viewing angle control panel as set forth in claim 32, wherein, in each of the two substrates, the two wire electrodes of each of the plural pairs are provided in a single layer.

34. The viewing angle control panel as set forth in claim 32, wherein, in each of the two substrates, the two wire electrodes of each of the plural pairs are provided in different layers, respectively.

35. The viewing angle control panel as set forth in claim 34, wherein the two wire electrodes include a part where they overlap each other and a part where they do not overlap each other.

36. The viewing angle control panel as set forth in claim 27, wherein setting of electric potentials, applied to the two wire electrodes in each of the plural pairs included by the two substrates, is changed such that a direction in which visibility of the liquid crystal display device is limited is switched.

37. The viewing angle control panel as set forth in claim 1, wherein a vertically-aligned negative liquid crystal is adopted as the liquid crystal display layer.

38. The viewing angle control panel as set forth in claim 1, wherein the wire electrodes have a light transmitting property.

39. A viewing angle control panel as set forth in claim 1, further comprising two polarization plates between which the two substrates are sandwiched.

40. A viewing angle control panel comprising two substrates facing each other and liquid crystal layer provided between the substrates, a combination of said viewing angle control panel and a display panel constituting a liquid crystal display device in which a viewing angle characteristic can be switched, wherein:
one of the two substrates includes a counter electrode pattern in which a counter electrode is provided over said one of the two substrates; and
the other one of the two substrates includes (i) a transparent electrode pattern in which transparent electrodes are provided in a striped manner and (ii) a first wire electrode and a second wire electrode, being provided in parallel with transparent electrodes so as to correspond to respective of spaces between the transparent electrodes in the transparent electrode pattern and such that the first and second wire electrodes and the respective of the spaces overlap each other, respectively.

41. A viewing angle control panel comprising two substrates facing each other and a liquid crystal layer provided between the substrates, a combination of said viewing angle control panel and a display panel constituting a liquid crystal display device in which a viewing angle characteristic can be switched, wherein:
one of the two substrates includes a counter electrode pattern in which a counter electrode is provided over said one of the two substrates; and
the other one of the two substrates includes (i) a transparent electrode pattern in which transparent electrodes are provided in a striped manner and (ii) plural pairs of two wire electrodes that are provided between the counter electrode pattern and the transparent electrode pattern, two wire electrodes of each of the plural pairs being provided in parallel with each other and being close to or overlapping each other in a width direction orthogonal to a direction in which the wire electrodes extend and orthogonal to a normal direction of a substrate surface.

42. A viewing angle control panel comprising two substrates facing each other and a liquid crystal layer provided between the substrates, a combination of said viewing angle control panel and a display panel constituting a liquid crystal display device in which a viewing angle characteristic can be switched, wherein:
one of the two substrates includes (i) a transparent electrode pattern in which transparent electrodes are provided in a striped manner and (ii) first and second wire electrodes, being provided in parallel with transparent electrodes so as to correspond to respective of spaces between the transparent electrodes in the transparent electrode pattern and such that the first and second wire electrodes and the respective of the spaces overlap each other, respectively; and
the other one of the two substrates includes (i) a transparent electrode pattern in which transparent electrodes are provided in a striped manner and (ii) first and second wire electrodes, being provided in parallel with transparent electrodes so as to correspond to respective of spaces between the transparent electrodes in the transparent electrode pattern and such that the first and second wire electrodes and the respective of the spaces overlap each other, respectively; and
the two substrates are provided so that their transparent electrodes are orthogonal to each other.

43. A viewing angle control panel comprising two substrates facing each other and a liquid crystal layer provided between the substrates, a combination of said viewing angle control panel and a display panel constituting a liquid crystal display device in which a viewing angle characteristic can be switched, wherein:
one of the two substrates includes (i) a transparent pattern in which a transparent electrode is provided over said one of the two substrates and (ii) plural pairs of two wire electrodes that are provided between the transparent electrode pattern and the liquid crystal layer, two wire electrodes of each of the plural pairs being provided in parallel with each other, and being close to or overlapping each other in a given direction parallel to a substrate surface;
the other one of the two substrates includes (i) a transparent electrode pattern in which a transparent electrode is provided over the other one of the two substrates and (ii) plural pairs of two wire electrodes that are provided between the transparent pattern and the liquid crystal layer, two wire electrodes of each of the plural pairs being provided in parallel with each other, and being close to or overlapping each other in a given direction parallel to a substrate surface; and
the two substrates are provided so that their wire electrodes are orthogonal to each other.

44. A liquid crystal display device, including:
a viewing angle control panel as set forth in claim 1; and
a display panel.

45. The viewing angle control panel as set forth in claim 19, wherein setting of electric potentials, being applied to the two wire electrodes in each of the plural pairs, is changed so that a direction in which visibility of the liquid crystal display device is limited is changed.

46. The viewing angle control panel as set forth in claim 32, wherein setting of electric potentials, applied to the two wire electrodes in each of the plural pairs included by the two substrates, is changed such that a direction in which visibility of the liquid crystal display device is limited is switched.

47. The viewing angle control panel as set forth in claim 19, wherein a vertically-aligned negative liquid crystal is adopted as the liquid crystal display layer.

48. The viewing angle control panel as set forth in claim 27, wherein a vertically-aligned negative liquid crystal is adopted as the liquid crystal display layer.

49. The viewing angle control panel as set forth in claim 32, wherein a vertically-aligned negative liquid crystal is adopted as the liquid crystal display layer.

50. The viewing angle control panel as set forth in claim 19, wherein the wire electrodes have a light transmitting property.

51. The viewing angle control panel as set forth in claim 27, wherein the wire electrodes have a light transmitting property.

52. The viewing angle control panel as set forth in claim 32, wherein the wire electrodes have a light transmitting property.

53. A viewing angle control panel as set forth in claim 19, further comprising two polarization plates between which the two substrates are sandwiched.

54. A viewing angle control panel as set forth in claim 27, further comprising two polarization plates between which the two substrates are sandwiched.

55. A viewing angle control panel as set forth in claim 32, further comprising two polarization plates between which the two substrates are sandwiched.

56. A liquid crystal display device, including:
a viewing angle control panel as set forth in claim 19; and
a display panel.

57. A liquid crystal display device, including:
a viewing angle control panel as set forth in claim 27; and
a display panel.

58. A liquid crystal display device, including:
a viewing angle control panel as set forth in claim 32; and
a display panel.

59. A liquid crystal display device, including:
a viewing angle control panel as set forth in claim 40; and
a display panel.

60. A liquid crystal display device, including:
a viewing angle control panel as set forth in claim 41; and
a display panel.

61. A liquid crystal display device, including:
a viewing angle control panel as set forth in claim 42; and
a display panel.

62. A liquid crystal display device, including:
a viewing angle control panel as set forth in claim 43; and
a display panel.
